(19) United States
(12) Patent Application Publication
(10) Pub. No.: US 2026/0343067 A1
(43) Pub. Date: Oct. 29, 2026

(54) Method for Detecting Stuttering in Playing of Multimedia Content and Electronic Device

(71) Applicant: HUAWEI TECHNOLOGIES CO., LTD., Shenzhen (CN)

(72) Inventors: Fusheng Shen, Shenzhen (CN); Yujuan Shen, Shanghai (CN); Chao Li, Shanghai (CN); Shouzheng Liu, Shenzhen (CN)

(73) Assignee: HUAWEI TECHNOLOGIES CO., LTD., Shenzhen (CN)

(21) Appl. No.: 19/569,509

(22) Filed: Mar. 17, 2026

Related U.S. Application Data
(63) Continuation of application No. PCT/CN2024/134989, filed on Nov. 27, 2024.

(30) Foreign Application Priority Data
Nov. 29, 2023 (CN) 202311626999.6

(51) Int. Cl. H04N 21/6371; H04N 21/647; H04N 21/6587

(52) U.S. Cl. CPC H04N 21/6371; H04N 21/6473; H04N 21/6587

(57) ABSTRACT

In a method for detecting stuttering in playing of multimedia content, when an electronic device receives a preset operation when displaying a multimedia content playing interface, a stuttering detection module of the electronic device may detect whether a multimedia application reports a playing start event within a preset time period starting from time at which the preset operation acts. If not receiving, within the preset time period, the playing start event reported by the multimedia application, the stuttering detection module may indicate the electronic device to adjust a network, so that the electronic device uses a network with better quality to perform communication.

### CROSS-REFERENCE TO RELATED APPLICATIONS

This is a continuation of Int'l Patent App. No. PCT/CN2024/134989 filed on Nov. 27, 2024, which claims priority to Chinese Patent App. No. 202311626999.6 filed on Nov. 29, 2023, both of which are incorporated by reference.

### TECHNICAL FIELD

This disclosure relates to the field of terminal technologies, and in particular, to a method for detecting stuttering in playing of multimedia content and an electronic device.

### BACKGROUND

Multimedia content may include an audio and/or a video. For example, some multimedia content is an independent audio, and there is sound that can be heard but no video picture that can be viewed during playing. Some other multimedia content is an independent video, and there are video pictures that can be viewed but no sound that can be heard during playing. Some multimedia content is a combination of an audio and a video, and there are both sound that can be heard and video pictures that can be viewed during playing.

When multimedia content is played online, stuttering often occurs due to a poor network and the like. Currently, whether stuttering occurs in the multimedia content is generally detected based on parameters such as signal strength and a network transmission delay. However, based on a caching technology, an electronic device usually caches a part of data for playing during playing of the multimedia content. When the network is poor, the electronic device may be performing playing by using the cached data. In this case, no stuttering occurs in the multimedia content. Therefore, stuttering in playing of the multimedia content and the network being poor do not necessarily occur synchronously. The foregoing method in which stuttering in an audio/video is determined upon detection of the poor network has low accuracy.

### SUMMARY

This disclosure provides a method for detecting stuttering in playing of multimedia content and an electronic device. Whether stuttering occurs in the multimedia content is detected with reference to a user operation on the electronic device and a multimedia playing event, so that accuracy of detecting stuttering in playing of the multimedia content can be improved.

According to a first aspect, this disclosure provides a method for detecting stuttering in playing of multimedia content. The method is applied to an electronic device, the electronic device includes a first application, and the first application may be an application that plays the multimedia content. The electronic device receives a first operation on a first interface, where the first interface is an interface that is of the first application and that is used to control playing of the multimedia content, and the first operation is used to play first multimedia content; and when the electronic device does not obtain, after the first operation, a first playing start event reported by the first application, the electronic device adjusts a network for performing data communication, where the first playing start event indicates that playing of the first multimedia content is started. The first playing start event may be reported by the first application when the first application obtains playing data of the first multimedia content.

The first playing start event reported by the first application is not obtained, which may indicate that playing of the first multimedia content has not started.

For the first interface, refer to a user interface 310 shown in FIG. 3A in this disclosure. For the first operation, refer to a swipe-up operation shown in FIG. 3C and FIG. 3D in this disclosure. For the first multimedia content, refer to an audio/video corresponding to a video picture 322 shown in FIG. 3D.

It can be learned that, in the foregoing method, whether the electronic device smoothly plays the multimedia content without stuttering when the user triggers the electronic device to play the multimedia content can be accurately identified. When the electronic device pre-caches the playing data of the multimedia content, even if a network of the electronic device is poor when the user triggers the electronic device to play the multimedia content, a multimedia application may obtain the pre-cached playing data, immediately play the multimedia content in response to the user operation, and report the playing start event. The electronic device can detect, based on the user operation and the playing start event, that no stuttering occurs in the multimedia content. This can reduce cases in which the electronic device, while smoothly playing the multimedia content in response to the user operation, incorrectly detects, based on a parameter indicating a poor network, that stuttering occurs in playing of the multimedia content. The foregoing method can improve accuracy of detecting stuttering in playing of the multimedia content.

In addition, when detecting stuttering in playing of the multimedia content, the electronic device may adjust the network, to eliminate stuttering as soon as possible, thereby improving user experience of listening to and watching the multimedia content.

With reference to the first aspect, in some embodiments, the first operation matches a preset operation. The preset operation may be associated with the first application. That is, the electronic device may store a table of correspondences between the multimedia application and different preset operations. A preset operation associated with a multimedia application may be an operation that acts on the multimedia application to control a multimedia content playing interface and that is used to trigger playing of the multimedia content. Optionally, the preset operation may be associated with the first interface. That is, the electronic device may store a table of correspondences between the multimedia playing interface and different preset operations. A preset operation associated with a multimedia playing interface may be an operation that acts on the multimedia playing interface and that is used to trigger playing of the multimedia content.

It can be learned that the electronic device may determine, by determining whether the first operation matches the preset operation, whether the first operation is an operation for triggering playing of the multimedia content, and then determine whether to wait for the playing start event to detect whether stuttering occurs in playing of the multimedia content. In this way, cases in which stuttering in playing of the multimedia content is incorrectly detected when a received operation does not match the preset operation can be reduced, and accuracy of detecting stuttering in playing of the multimedia content is improved.

With reference to the first aspect, in some embodiments, the network for performing data communication is adjusted from a first network to a second network, the first application in the electronic device obtains playing data of the first media content by using the second network, and the electronic device plays the first multimedia content based on the playing data of the first multimedia content.

Quality of the second network is better than quality of the first network.

That the network for performing data communication is adjusted from the first network to the second network may include but is not limited to: adjusting from a Wi-Fi network to a cellular mobile network, adjusting from a cellular mobile network corresponding to a primary SIM card to a cellular mobile network corresponding to a secondary SIM card, adjusting from a cellular mobile network of one standard to a cellular mobile network of another standard (for example, from a 4G cellular mobile network to a 5G cellular mobile network), adjusting a cellular mobile network from one camping cell to another camping cell, and the like.

It can be learned that, when it is detected that stuttering occurs in playing of the multimedia content, the electronic device may adjust the network, to use a network with better quality to perform communication. In this way, the electronic device can obtain the playing data of the multimedia content as soon as possible, to eliminate stuttering in playing of the multimedia content.

With reference to the first aspect, in some embodiments, after the electronic device adjusts the network for performing data communication, the electronic device changes a first indicator on the first interface to a second indicator, where the first indicator indicates that the network for performing data communication is the first network, and the second indicator indicates that the network for performing data communication is the second network.

For the first indicator, refer to a Wi-Fi indicator 311B shown in FIG. 3G in this disclosure. For the second indicator, refer to a cellular mobile network indicator 311E shown in FIG. 3H in this disclosure.

With reference to the first aspect, in some embodiments, that the electronic device plays the first multimedia content based on the playing data of the first multimedia content may specifically include: The electronic device plays a first audio and/or playing a first video based on the playing data of the first multimedia content.

With reference to the first aspect, in some embodiments, in a process of playing the first multimedia content, stuttering occurs in playing of the first multimedia content by the electronic device; and the electronic device detects a first data timeout event, and adjusts, based on the first data timeout event, the network for performing data communication, where the first data timeout event indicates that the playing data used for playing the first multimedia content in the electronic device times out and no playing data is currently available.

It can be learned that the first data timeout event may reflect that stuttering occurs in a playing process of the first multimedia content. The electronic device may accurately detect, based on the first data timeout event, whether stuttering occurs in the playing process of the first multimedia content, adjust the network when stuttering occurs in playing of the multimedia content, and perform communication by using a network with better quality to eliminate stuttering. In this way, audio listening experience of the user can be improved.

With reference to the first aspect, in some embodiments, when the electronic device obtains, after the first operation, the first playing start event reported by the first application, the electronic device plays the first multimedia content, where the playing data of the first multimedia content is obtained by the first application from a memory, or is obtained by the first application by using the network for data communication.

With reference to the first aspect, in some embodiments, the electronic device receives a second operation on the first interface, where the second operation does not match the preset operation; or the electronic device receives a third operation on a second interface, where the second interface is not an interface used to control playing of the multimedia content; and the electronic device waits to receive a subsequent user operation.

It can be learned that, when the received operation does not match the preset operation, the electronic device may not need to wait for the playing start event to perform detection of stuttering in playing of the multimedia content. In this way, cases of incorrect detection of stuttering in playing of the multimedia content can be reduced, and accuracy of detecting stuttering in playing of the multimedia content is improved.

With reference to the first aspect, in some embodiments, playing of the first multimedia content is paused. The electronic device receives a fourth operation on the first interface, where the fourth operation is used to play the first multimedia content; the electronic device identifies that the fourth operation acts in a first area on the first interface, where the fourth operation matches the preset operation; and the electronic device determines whether the first playing start event reported by the first application is obtained within a second time period, where the second time period is a preset time period starting from a second moment, and the second moment is time at which the second operation acts; and when the electronic device does not obtain, within the second time period, the first playing start event reported by the first application, the electronic device adjusts the network for performing data communication; or when the electronic device obtains, within the second time period, the first playing start event reported by the first application, the electronic device plays the first multimedia content.

The first area may be a preset area on the first interface. Different multimedia playing interfaces may correspond to different preset areas. The electronic device may more accurately identify, with reference to a playing status of the multimedia content, and a type and an action position of the user operation, the user operation used to trigger playing of the multimedia content, to detect, in more scenarios in which playing of the multimedia content is triggered through the user operation, whether stuttering occurs in to-be-played multimedia content.

With reference to the first aspect, in some embodiments, before the electronic device adjusts the network for performing data communication, the electronic device determines, based on activity information of the first interface, that the first interface is the interface used to the control playing of the multimedia content.

With reference to the first aspect, in some embodiments, before the electronic device adjusts the network for performing data communication, the electronic device detects that a data transmission indicator after the first operation indicates that network quality is poorer than preset network quality.

It may be understood that, when stuttering in playing of the multimedia content is determined based on the user operation and the multimedia playing event, the data transmission indicator indicating that the network quality is poorer than the preset network quality can indicate that stuttering in playing of the multimedia content is caused by the poor network quality. This improves a confidence level of a multimedia content stuttering detection result.

With reference to the first aspect, in some embodiments, the electronic device receives a fifth operation on the second interface, where the second interface is the interface that is of the first application and that is used to control playing of the multimedia content, and the fifth operation is used to play second multimedia content; and when the electronic device does not obtain, after the fifth operation, a second playing start event reported by the first application, and a data transmission indicator after the fifth operation indicates that network quality is better than the preset network quality, the electronic device terminates one or more processes, where the one or more processes are not processes of the first application, and the second playing start event indicates that playing of the second multimedia content is started. The second playing start event may be reported by the first application when the first application obtains playing data of the second multimedia content.

The second playing start event reported by the first application is not obtained, which may indicate that playing of the second multimedia content has not started.

The foregoing data transmission indicator is round trip time RTT.

It may be understood that, when it is determined, based on the user operation and the multimedia playing event, that stuttering occurs in the multimedia content, the data transmission indicator indicating that the network quality is better than the preset network quality can indicate that stuttering in the multimedia content is not caused by poor network quality. For example, if a processor of the electronic device is overloaded, and too many processes run in the background, stuttering may occur in the multimedia content. Therefore, the electronic device may determine, with reference to the data transmission indicator, whether stuttering in the multimedia content is caused by the poor network quality, and further determine whether the network needs to be adjusted to eliminate stuttering. This can eliminate a factor that causes stuttering in the multimedia content, resume smooth playing of the multimedia content, and improve user experience of listening to and watching the multimedia content.

With reference to the first aspect, in some embodiments, when the electronic device does not obtain the first playing start event within a first time period, the electronic device adjusts the network for performing data communication, where the first time period is a preset time period starting from a first moment, and the first moment is time at which the first operation acts.

In some embodiments, that the data transmission indicator after the first operation indicates that the network quality is poorer than the preset network quality may specifically include: all pieces of RTT within the first time period are greater than a preset RTT threshold, or an average value of pieces of RTT within the first time period is greater than the preset RTT threshold.

In some embodiments, when the electronic device does not obtain, after the fifth operation, the second playing start event reported by the first application, and the data transmission indicator after the fifth operation indicates that the network quality is better than the preset network quality, the electronic device terminates the one or more processes. Specifically, when the electronic device does not obtain, within a third time period, the second playing start event reported by the first application, and a data transmission indicator within the third time period indicates that network quality is better than the preset network quality, the electronic device terminates the one or more processes. The third time period may be a preset time period starting from a third moment. The third moment may be time at which the fifth operation acts.

That the data transmission indicator within the third time period indicates that the network quality is better than the preset network quality may specifically include: all pieces of RTT within the third time period are less than or equal to the preset RTT threshold, or an average value of pieces of RTT within the third time period is less than or equal to the preset RTT threshold.

According to a second aspect, this disclosure provides a method for detecting stuttering in browsing of an interface. The method may be applied to an electronic device, and the electronic device includes a first application. The electronic device receives a first operation on a first interface of a first application, where the first operation is used to switch, in the first application, display content on a screen of the electronic device; the electronic device obtains a data transmission indicator after the first operation, where the data transmission indicator indicates network quality for data communication performed by the electronic device; and if the data transmission indicator after the first operation indicates that the network quality is poorer than preset network quality, the electronic device adjusts a network for performing data communication.

The first interface may be an image-text interface on which a text and/or an image is displayed.

The first application may be a multimedia application, a browser, a news app, a shopping app, a reading app, or the like.

It can be learned that, in the foregoing method, whether stuttering occurs when a user browses the interface of the first application may be determined. When it is detected that stuttering occurs in browsing of an interface, the electronic device may adjust a network to use a network with better quality to perform communication. In this way, the electronic device can obtain, as soon as possible, data required for a display interface, to eliminate stuttering in browsing of the interface as soon as possible, and improve user experience in browsing the interface.

With reference to the second aspect, in some embodiments, the first interface matches a preset interface, and the first operation matches a preset operation.

In other words, the electronic device may determine, by determining whether the first operation is a preset operation acting on the preset interface, whether the first operation is a user operation used to switch, in the first application, display content on the screen of the electronic device.

With reference to the second aspect, in some embodiments, the first interface is a long page, and the first operation is used to switch the display content on the screen of the electronic device to content in a different area on the first interface. For example, the first operation may be a swipe-up or swipe-down operation acting on the first interface. In this way, the electronic device may switch and display, on the screen based on the first operation, content in different areas on the first interface. Alternatively, the first operation is used to switch the first interface to a second interface of the first application. For example, the first operation may be a swipe-left or swipe-right operation acting on the first interface. In this way, the electronic device may switch, based on the first operation, the content displayed on the screen to another interface on the left or the right of the first interface.

With reference to the second aspect, in some embodiments, the data transmission indicator after the first operation includes the data transmission indicator within a first time period, the first time period is a preset time period starting from a first moment, and the first moment is time at which the first operation acts.

With reference to the second aspect, in some embodiments, the data transmission indicator is round trip time RTT, and that the data transmission indicator after the first operation indicates that the network quality is poorer than the preset network quality specifically includes: all pieces of RTT within the first time period are greater than a preset RTT threshold, or an average value of pieces of RTT within the first time period is greater than the preset RTT threshold.

With reference to the second aspect, in some embodiments, the network for performing data communication is adjusted from a first network to a second network, and after the electronic device adjusts the network for performing data communication, the electronic device changes a first indicator on the first interface to a second indicator, where the first indicator indicates that the network for performing data communication is the first network, and the second indicator indicates that the network for performing data communication is the second network.

According to a third aspect, this disclosure provides an electronic device. The electronic device includes a memory and a processor. The memory is configured to store a computer program, and the processor is configured to invoke the computer program, so that the electronic device performs the method according to any one of the possible implementations of the first aspect or the second aspect.

According to a fourth aspect, this disclosure provides a computer-readable storage medium, including instructions. When the instructions are run on an electronic device, the electronic device is enabled to perform the method according to any one of the possible implementations of the first aspect or the second aspect.

According to a fifth aspect, this disclosure provides a computer program product. The computer program product may include computer instructions. When the computer instructions are run on an electronic device, the electronic device is enabled to perform the method according to any one of the possible implementations of the first aspect or the second aspect.

According to a sixth aspect, this disclosure provides a chip. The chip is used in an electronic device, the chip includes one or more processors, and the processor is configured to invoke computer instructions to enable the electronic device to perform the method according to any one of the possible implementations of the first aspect or the second aspect.

It may be understood that the electronic device provided in the third aspect, the computer-readable storage medium provided in the fourth aspect, the computer program product provided in the fifth aspect, and the chip provided in the sixth aspect are all configured to perform the methods provided in embodiments of this disclosure. Therefore, for beneficial effect that can be achieved by the electronic device, the computer-readable storage medium, the computer program product, and the chip, refer to the beneficial effect in the corresponding methods. Details are not described herein again.

### BRIEF DESCRIPTION OF DRAWINGS

FIG. 1 is a diagram of a hardware structure of an electronic device 100 according to an embodiment of this disclosure;

FIG. 2A is a diagram of a software structure of an electronic device 100 according to an embodiment of this disclosure;

FIG. 2B is a diagram of a structure of an electronic device 100 according to an embodiment of this disclosure;

FIG. 3A to FIG. 3H are diagrams of some scenarios of detecting stuttering in playing of multimedia content according to an embodiment of this disclosure;

FIG. 4A and FIG. 4B are diagrams of some scenarios of detecting stuttering in playing of multimedia content according to an embodiment of this disclosure;

FIG. 5A to FIG. 5C show a flowchart of a method for detecting stuttering in playing of multimedia content according to an embodiment of this disclosure; and

FIG. 6 is a flowchart of another method for detecting stuttering in playing of multimedia content according to an embodiment of this disclosure.

### DESCRIPTION OF EMBODIMENTS

The following describes the technical solutions in embodiments of this disclosure with reference to the accompanying drawings in embodiments of this disclosure. In the descriptions of embodiments of this disclosure, terms used in the following embodiments are merely intended to describe specific embodiments, but not to limit this disclosure. The terms “one”, “the”, “the foregoing”, “this”, and “the one” of singular forms used in this specification and the appended claims of this disclosure are also intended to include expressions such as “one or more”, unless otherwise specified in the context clearly. It should be further understood that, in the following embodiments of this disclosure, “at least one” and “one or more” mean one or more (including two). The term “and/or” is used to describe an association relationship between associated objects and represents that three relationships may exist. For example, A and/or B may represent the following cases: Only A exists, both A and B exist, and only B exists, where A and B may be singular or plural. The character “/” generally indicates an “or” relationship between the associated objects.

Reference to “one embodiment”, “some embodiments”, or the like described in this specification means that a specific feature, structure, or characteristic described with reference to the embodiment is included in one or more embodiments of this disclosure. Therefore, statements such as “in an embodiment”, “in some embodiments”, “in some other embodiments”, and “in other embodiments” that appear at different places in this specification do not necessarily mean referring to a same embodiment. Instead, the statements mean “one or more but not all of embodiments”, unless otherwise specifically emphasized in another manner. The terms “include”, “have”, and their variants all mean “include but are not limited to”, unless otherwise specifically emphasized in another manner. The term “connection” includes direct connection and indirect connection, unless otherwise specified. “First” and “second” are merely intended for description, and should not be understood as an indication or implication of relative importance or an implicit indication of a quantity of indicated technical features.

In embodiments of this disclosure, the term “example”, “for example”, or the like is used to give an example, an illustration, or a description. Any embodiment or design scheme described as an “example” or “for example” in embodiments of this disclosure should not be construed as being more preferred or more advantageous than another embodiment or design scheme. Exactly, use of the term “example”, “for example”, or the like is intended to present a related concept in a specific manner.

The following embodiments of this disclosure relate to a human-machine interface (HMI). The HMI is a medium interface for interaction and information exchange between an application (APP) or an operating system (OS) and a user, and implements conversion between an internal form of information and a form acceptable to the user. The HMI may include a user interface (UI), a physical button, a virtual gesture recognition module, and the like. The user interface is source code written in a specific computer language such as Java or an Extensible Markup Language (XML). Interface source code is parsed and rendered on an electronic device, and is finally presented as content that can be identified by the user. The user interface is usually represented in a form of graphical user interface (GUI), and is a user interface that is related to a computer operation and that is displayed in a graphic manner. The user interface may be a visual interface element like a text, an icon, a button, a menu, a tab, a text box, a dialog box, a status bar, a navigation bar, or a widget that is displayed on a display of the electronic device. The virtual gesture recognition module may be configured to recognize a virtual gesture of the user for the electronic device, for example, a mid-air gesture.

This disclosure provides a method for detecting stuttering in playing of multimedia content. Whether stuttering occurs in multimedia content is detected with reference to a user operation on an electronic device and a multimedia playing event, so that accuracy of detecting stuttering in playing of the multimedia content can be improved. A multimedia application may be an app that can play an audio and/or a video. For example, the multimedia application may include but is not limited to a music app, a movie app, a short video app, a social app, and the like. The multimedia application is not limited in embodiments of this disclosure. The multimedia application may also be referred to as a name like an audio/video playing application.

Specifically, when starting to play the multimedia content, the multimedia application may report a playing start event to a multimedia processing module in the electronic device. When an interface currently displayed on the electronic device is a multimedia playing interface of the multimedia application, if the electronic device receives a preset operation, the electronic device may detect whether the multimedia application reports the playing start event after the preset operation. The preset operation may include an operation of triggering the multimedia application to play the multimedia content, for example, a swipe-up operation, a swipe-down operation, and the like. After the preset operation, the multimedia application reports the playing start event, which may indicate that no stuttering occurs in playing of the multimedia content. After the preset operation, the multimedia application does not report the playing start event, which may indicate that stuttering occurs in playing of the multimedia content. When it is detected that stuttering occurs in playing of the multimedia content, the electronic device may perform an operation such as network adjustment, and perform communication by using a network with better quality. This can reduce stuttering duration, and improve user experience of listening to and watching the multimedia content.

The foregoing “after the preset operation” may include a preset time period starting from time at which the preset operation acts. In other words, the electronic device may detect whether the multimedia application reports the playing start event within the preset time period starting from the time at which the preset operation acts.

It may be understood that, after the electronic device receives the preset operation, the multimedia application needs to respond to the preset operation to obtain playing data (for example, audio data and/or video data) of the multimedia content to play the multimedia content. The playing data of the multimedia content may be pre-cached by the electronic device, or may be obtained by the electronic device in real time based on a communication network. When the multimedia application can immediately obtain the playing data of the multimedia content, the multimedia application may immediately play the multimedia content, and report the playing start event. In this way, when the user triggers, through an operation, the multimedia application to play the multimedia content, the multimedia application can quickly load the playing data, and no stuttering occurs in playing of the multimedia content. Therefore, when no stuttering occurs in playing of the multimedia content, after receiving the preset operation, the electronic device usually can quickly obtain the playing start event reported by the multimedia application. However, if the network is poor, and the multimedia application cannot obtain the playing data of the multimedia content in time, the multimedia application does not report the playing start event in time. In this way, when the user triggers, through the operation, the multimedia application to play the multimedia content, the multimedia application cannot quickly load the playing data, and therefore cannot respond to the user operation in time to play the multimedia content, and stuttering occurs in the multimedia content. Therefore, when stuttering occurs in playing of the multimedia content, after receiving the preset operation, the electronic device may wait for a long period of time before obtaining the playing start event reported by the multimedia application, or even may not obtain the playing start event reported by the multimedia application.

According to the foregoing method, whether the electronic device smoothly plays the multimedia content without stuttering when the user triggers the electronic device to play the multimedia content can be accurately identified. When the electronic device pre-caches the playing data of the multimedia content, even if a network of the electronic device is poor when the user triggers the electronic device to play the multimedia content, the multimedia application may obtain the pre-cached playing data, immediately play the multimedia content in response to the user operation, and report the playing start event. The electronic device can detect, based on the user operation and the playing start event, that no stuttering occurs in the multimedia content. This can reduce cases in which the electronic device, while smoothly playing the multimedia content in response to the user operation, incorrectly detects, based on a parameter indicating a poor network, that stuttering occurs in playing of the multimedia content. The foregoing method can improve accuracy of detecting stuttering in playing of the multimedia content.

In some embodiments, a multimedia playing event may be classified into an audio event and a video event. The audio event may indicate a playing status of an audio. The video event may indicate a playing status of a video. For an independent audio, the electronic device may detect, based on the audio event, whether stuttering occurs in playing of the audio. For an independent video, the electronic device may detect, based on the video event, whether stuttering occurs in playing of the video. For multimedia content combining an audio and a video, because the audio and the video are played synchronously, the electronic device may detect, based on the audio event, whether stuttering occurs in playing of the audio/video, or may detect, based on the video event, whether stuttering occurs in playing of the audio/video.

The multimedia processing module in the electronic device may include an audio module and a video module. The multimedia application may report the audio event to the audio module, and report the video event to the video module.

For ease of understanding, the “audio event” in this disclosure is described herein.

When playing an audio, the multimedia application may report, based on a playing status of the audio, a corresponding audio event to the audio module responsible for audio management and control in the electronic device. The audio event may include but is not limited to: a playing start event, a playing pause event, a playing stop event, a data timeout event, a data resume event, and the like.

The start event may be reported when the multimedia application starts to play the audio. That the multimedia application starts to play the audio may include: The multimedia application plays from a start position of the audio, and the multimedia application continues to play the audio after playing of the audio is paused.

The pause event may be reported when the multimedia application pauses playing of the audio. In response to a user operation of pausing playing the audio, the multimedia application may report the pause event. When playing of the audio is paused, the electronic device may save a progress of the audio when playing is paused, so that playing can be resumed.

The stop event may be reported when the multimedia application stops playing of the audio. When playing of the audio ends or the audio is switched to another audio, the multimedia application can report the stop event. In some embodiments, the audio module may independently determine the stop event without reporting by the multimedia application. For example, the audio module may determine, based on obtained data used to play the audio, a moment at which playing of the audio stops, to determine the stop event of the audio.

The timeout event may be an event between the start event and the pause event, or an event between the start event and the stop event. The timeout event may indicate that, for over preset duration, there is no audio data that can be used for playing in a process of playing the audio by the multimedia application. The preset duration may be, for example, a value like 500 milliseconds (ms) or 1 second(s). The value of the preset duration is not limited in embodiments of this disclosure. The multimedia application starts to be in an audio playing state when reporting the start event. The multimedia application can play the audio while obtaining subsequent audio data. Based on a caching technology, the multimedia application may pre-cache audio data in a subsequent period of time following a current playing position. In this way, when the network is temporarily poor and the audio data cannot be obtained, the multimedia application can still use the cached audio data to play the audio. If playing based on the cached audio data ends but the network is still poor and the subsequent audio data cannot be obtained, stuttering occurs in the audio. The multimedia application may send the audio data to the audio module. The audio module may play the audio based on the received audio data. For over the preset duration after receiving the start event, if the audio module has no audio data that can be used for playing, the audio module may determine the timeout event of the audio.

The resume event may be an event after the timeout event. The resume event indicates that there is audio data that can be used for resuming playing in a process of playing the audio by the audio module. After the timeout event of the audio is determined, the audio module may wait for subsequent audio playing data. When audio data is obtained again, the audio module may determine the resume event of the audio. In some embodiments, the audio module may generate the resume event of the audio after continuously obtaining audio data within a period of time (for example, 500 ms, 1 s, or 2 s). The foregoing continuously obtaining the audio data within the period of time may indicate that a network is currently stable and good.

In some embodiments, in a scenario in which the played audio is switched from an audio a1 to an audio a2, the multimedia application may report a stop event of the audio a1 and a start event of the audio a2. The stop event of the audio a1 may indicate that playing of the audio a1 stops. The start event of the audio a2 may indicate that playing of the audio a2 is started. A sequence of reporting the stop event and the start event is not limited in this disclosure.

In a scenario of playing the audio a1, in response to a pause playing operation, the multimedia application may report a pause event. Then, in response to the operation of continuing playing the audio a1, the multimedia application may report the start event.

It can be learned that each audio may independently correspond to an audio event. The multimedia application may report an audio event corresponding to an audio based on a playing status of the audio. When the played audio is switched to another audio, the multimedia application may report an audio event corresponding to the another audio.

The foregoing audio events are merely examples for description of this disclosure, and should not constitute a limitation on this disclosure. The multimedia application may also report other types of audio events.

In some embodiments, the video event may also include a playing start event, a playing pause event, a playing stop event, a data timeout event, a data resume event, and the like. For a type of the video event, refer to the description of the audio event. Details are not described herein.

In subsequent embodiments of this disclosure, a method for detecting stuttering in this disclosure is specifically described by using an example in which an electronic device detects stuttering in playing of multimedia content based on a user operation event and an audio event. For a method for detecting, by the electronic device, stuttering in playing of the multimedia content based on the user operation event and the video event, refer to a method for detecting stuttering in playing of the multimedia content based on the user operation event and the audio event.

The following describes a structure of an electronic device in this disclosure.

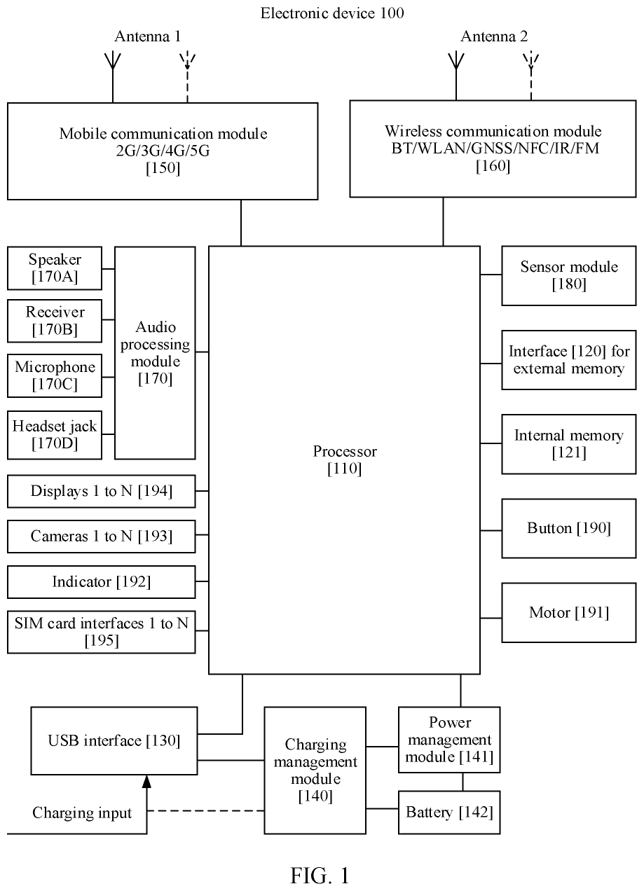

FIG. 1 is a diagram of an example of a hardware structure of an electronic device 100.

As shown in FIG. 1, the electronic device 100 may include a processor 110, an interface 120 for external memory, an internal memory 121, a Universal Serial Bus (USB) interface 130, a charging management module 140, a power management module 141, a battery 142, an antenna 1, an antenna 2, a mobile communication module 150, a wireless communication module 160, an audio processing module 170, a speaker 170A, a receiver 170B, a microphone 170C, a headset jack 170D, a sensor module 180, a button 190, a motor 191, an indicator 192, a camera 193, a display 194, a subscriber identity module (SIM) card interface 195, and the like.

It may be understood that the structure shown in embodiments of this disclosure does not constitute a specific limitation on the electronic device 100. In some other embodiments of this disclosure, the electronic device 100 may include more or fewer components than those shown in the figure, or some components may be combined, or some components may be split, or different component arrangements may be used. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a memory, a video codec, a digital signal processor (DSP), a baseband processor, a neural-network processing unit (NPU), and/or the like. Different processing units may be independent components, or may be integrated into one or more processors.

The controller may be a nerve center and a command center of the electronic device 100. The controller may generate an operation control signal based on instruction operation code and a time sequence signal, to complete control of instruction fetching and instruction execution.

A memory may be further disposed in the processor 110, and is configured to store instructions and data. In some embodiments, the memory in the processor 110 is a cache. The memory may store instructions or data that has been used or is cyclically used by the processor 110. If the processor 110 needs to use the instructions or the data again, the processor may directly invoke the instructions or the data from the memory. This avoids repeated access, reduces waiting time of the processor 110, and improves system efficiency.

The USB interface 130 is an interface complying with a USB standard. The USB interface 130 may be configured to connect to a charger to charge the electronic device 100, or may be configured to transmit data between the electronic device 100 and a peripheral device, or may be configured to connect to a headset for playing an audio through the headset.

The charging management module 140 is configured to receive a charging input from a charger. The charger may be a wireless charger or a wired charger. The charging management module 140 supplies power to the electronic device through the power management module 141 while charging the battery 142.

The power management module 141 is configured to connect to the battery 142, the charging management module 140, and the processor 110. The power management module 141 receives an input of the battery 142 and/or the charging management module 140, to supply power to the processor 110, the internal memory 121, an external memory, the display 194, the camera 193, the wireless communication module 160, and the like.

A wireless communication function of the electronic device 100 may be implemented through the antenna 1, the antenna 2, the mobile communication module 150, the wireless communication module 160, the modem processor, the baseband processor, and the like.

The antenna 1 and the antenna 2 are configured to transmit and receive an electromagnetic wave signal. Each antenna in the electronic device 100 may be configured to cover one or more communication frequency bands. Different antennas may be further multiplexed, to improve antenna utilization. For example, the antenna 1 may be multiplexed as a diversity antenna of a wireless local area network. In some other embodiments, the antenna may be used in combination with a tuning switch.

The mobile communication module 150 may provide a wireless communication solution that is applied to the electronic device 100 and that includes 2G/3G/4G/5G or the like. The mobile communication module 150 may include at least one filter, a switch, a power amplifier, a low-noise amplifier (LNA), and the like. The mobile communication module 150 may receive an electromagnetic wave through the antenna 1, perform processing such as filtering or amplification on the received electromagnetic wave, and transmit the electromagnetic wave to the modem processor for demodulation. The mobile communication module 150 may further amplify a signal modulated by the modem processor, and convert the signal into an electromagnetic wave for radiation through the antenna 1.

The wireless communication module 160 may provide a wireless communication solution that is applied to the electronic device 100 and that includes a wireless local area network (WLAN) (for example, a Wi-Fi network), Bluetooth (BT), a global navigation satellite system (GNSS), frequency modulation (FM), a near-field communication (NFC) technology, an infrared (IR) technology, or the like. The wireless communication module 160 may be one or more devices integrating at least one communication processing module. The wireless communication module 160 receives an electromagnetic wave through the antenna 2, performs frequency modulation and filtering processing on the electromagnetic wave signal, and sends a processed signal to the processor 110. The wireless communication module 160 may further receive a to-be-sent signal from the processor 110, perform frequency modulation and amplification on the signal, and convert a processed signal into an electromagnetic wave for radiation through the antenna 2.

The electronic device 100 may implement a display function through the GPU, the display 194, the application processor, and the like. The GPU is a microprocessor for image processing, and is connected to the display 194 and the application processor. The GPU is configured to: perform mathematical and geometric computation, and render an image.

The display 194 is configured to display an image, a video, and the like. In some embodiments, the electronic device 100 may include one or N displays 194, where N is a positive integer greater than 1.

The electronic device 100 may implement a photographing function through the camera 193, the ISP, the video codec, the GPU, the display 194, the application processor and the like.

The ISP is configured to process data fed back by the camera 193. For example, during photographing, a shutter is pressed, and light is transmitted to a photosensitive element of the camera through a lens. An optical signal is converted into an electrical signal, and the photosensitive element of the camera transmits the electrical signal to the ISP for processing, to convert the electrical signal into a visible image.

The camera 193 is configured to capture a static image or a video. In some embodiments, the electronic device 100 may include one or N cameras 193, where N is a positive integer greater than 1.

The digital signal processor is configured to process a digital signal, and may process another digital signal in addition to the digital image signal. For example, when the electronic device 100 selects a frequency, the digital signal processor is configured to perform Fourier transformation on frequency energy.

The NPU is a neural-network (NN) computing processor. The NPU quickly processes input information with reference to a structure of a biological neural network, for example, a transfer mode between human brain neurons, and may further continuously perform self-learning. Applications such as intelligent cognition of the electronic device 100 may be implemented through the NPU, for example, image recognition, facial recognition, speech recognition, and text understanding.

The interface 120 for external memory may be configured to connect to an external storage card, for example, a micro SD card, to extend a storage capability of the electronic device 100. The external memory card communicates with the processor 110 through the interface 120 for external memory, to implement a data storage function. For example, files such as music and videos are stored in the external storage card.

The internal memory 121 may be configured to store computer-executable program code. The executable program code includes instructions. The processor 110 runs the instructions stored in the internal memory 121, to perform various function applications of the electronic device 100 and data processing. The internal memory 121 may include a program storage area and a data storage area. The program storage area may store an operating system, an application required by at least one function (for example, a user operation detection function, an audio playing function, and a video playing function), and the like. The data storage area may store data (for example, audio data or an address book) and the like created when the electronic device 100 is used. In addition, the internal memory 121 may include a high-speed random access memory, or may include a nonvolatile memory, for example, at least one magnetic disk storage device, a flash memory, or a Universal Flash Storage (UFS).

The electronic device 100 may implement an audio function, for example, music playing and recording, through the audio processing module 170, the speaker 170A, the receiver 170B, the microphone 170C, the headset jack 170D, the application processor, and the like.

The audio processing module 170 is configured to convert digital audio information into an analog audio signal for output, and is also configured to convert analog audio input into a digital audio signal. The audio processing module 170 may be further configured to encode and decode an audio signal. In some examples, the audio processing module 170 may be disposed in the processor 110, or a part of functional modules of the audio processing module 170 are disposed in the processor 110. The speaker 170A, also referred to as a “loudspeaker”, is configured to convert an audio electrical signal into a sound signal. The receiver 170B, also referred to as an “earpiece”, is configured to convert an electrical audio signal into a sound signal. The microphone 170C, also referred to as a “mike” or a “mic”, is configured to convert a sound signal into an electrical signal. The headset jack 170D is configured to connect to a wired headset.

The sensor module 180 may include a pressure sensor, a gyroscope sensor, a barometric pressure sensor, a magnetic sensor, an acceleration sensor, a gravity sensor, a distance sensor, an optical proximity sensor, a fingerprint sensor, a temperature sensor, a touch sensor, an ambient light sensor, a bone conduction sensor, and the like.

The button 190 includes a power button, a volume button, and the like. The motor 191 may generate a vibration prompt. The indicator 192 may be an indicator light, and may be configured to indicate a charging status and a power change, or may be configured to indicate a message, a missed call, a notification, and the like.

The SIM card interface 195 is configured to connect to a SIM card. The SIM card may be inserted into the SIM card interface 195 or removed from the SIM card interface 195, to implement contact with or separation from the electronic device 100. The electronic device 100 may support one or N SIM card interfaces, where N is a positive integer greater than 1. The electronic device 100 interacts with a network through the SIM card, to implement functions such as conversation and data communication. In some examples, the electronic device 100 uses an eSIM, namely, an embedded SIM card. The eSIM card may be embedded into the electronic device 100, and cannot be separated from the electronic device 100.

The electronic device 100 may be a mobile phone, a tablet computer, a notebook computer, an ultra-mobile personal computer (UMPC), a netbook, a personal digital assistant (PDA), and the like. A specific type of the electronic device 100 is not limited in embodiments of this disclosure.

A software system of the electronic device 100 may use a layered architecture, an event-driven architecture, a microkernel architecture, a microservice architecture, or a cloud architecture. In this embodiment of this disclosure, an Android® system with a layered architecture is used as an example to illustrate a software structure of the electronic device 100.

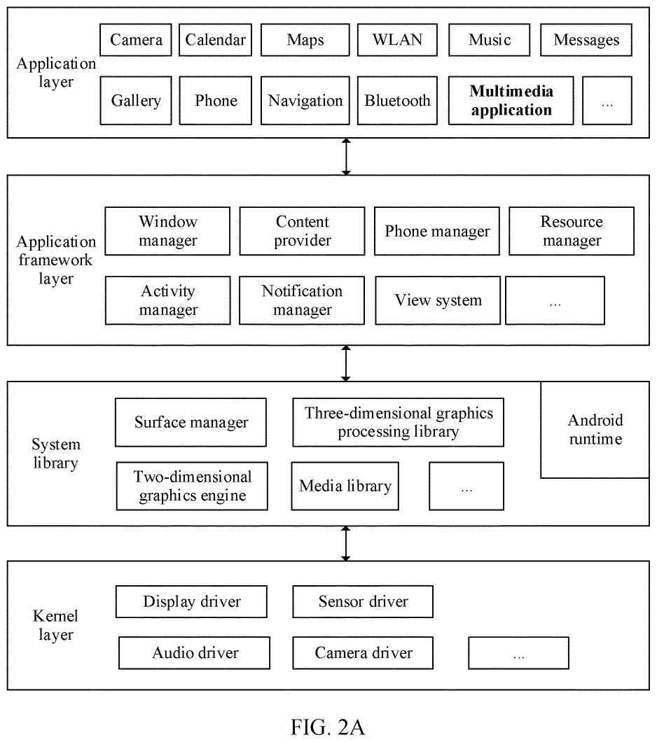

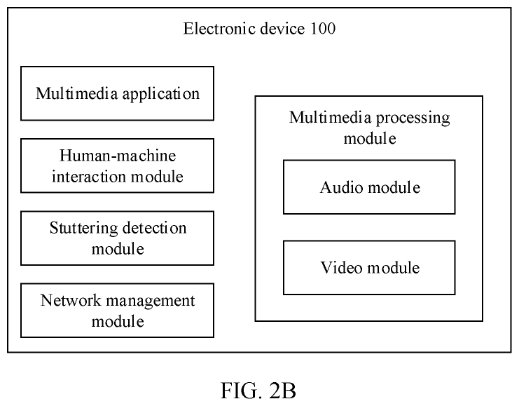

FIG. 2A is a diagram of an example of a software structure of the electronic device 100.

In a layered architecture, software is divided into several layers, and each layer has a clear role and task. The layers communicate with each other through a software interface. In some embodiments, the Android® system is divided into four layers that are respectively an application layer, an application framework layer, an Android runtime and system library, and a kernel layer from top to bottom.

The application layer may include a series of application packages.

As shown in FIG. 2A, the application packages may include applications such as Camera, Gallery, Calendar, Phone, Maps, Navigation, WLAN, Bluetooth, Music, Messages, and Multimedia application. The multimedia application may be a type of an app that is in the electronic device 100 and that is related to playing of an audio/video.

The application framework layer provides an API and a programming framework for an application at the application layer. The application framework layer includes some predefined functions.

As shown in FIG. 2A, the application framework layer may include a window manager, a content provider, a view system, a phone manager, a resource manager, a notification manager, an activity manager, and the like.

The window manager is configured to manage a window program. The window manager may obtain a size of the display, determine whether there is a status bar, perform screen locking, take a screenshot, and the like.

The content provider is configured to: store and obtain data, and enable the data to be accessed by an application. The data may include a video, an image, an audio, calls that are made and answered, a browsing history and bookmarks, an address book, and the like.

The view system includes visual controls such as a control for displaying a text and a control for displaying an image. The view system may be configured to construct an application. A display interface may include one or more views. For example, a display interface including a messages notification icon may include a text display view and an image display view.

The phone manager is configured to provide a communication function for the electronic device 100, for example, management of a call status (including answering, declining, or the like).

The resource manager provides various resources such as a localized character string, an icon, an image, a layout file, and a video file for an application.

The notification manager enables an application to display notification information in the status bar (for example, a pull-down notification bar), and may be configured to transmit a notification-type message. The displayed information may automatically disappear after a short pause without user interaction. For example, the notification manager is configured to notify download completion, give a message notification, and the like. The notification manager may alternatively be a notification that appears in a top status bar of the system in a form of graph or scroll bar text, for example, a notification of an application that is run on a background, or may be a notification that appears on the screen in a form of dialog window. For example, text information is displayed in the status bar, an alert tone is given, the electronic device vibrates, or the indicator light blinks.

The activity manager is responsible for managing an activity, and is responsible for starting, switching, and scheduling each component in a system, and managing and scheduling an application. The activity manager can be invoked by an upper-layer application to start a corresponding activity.

An activity is an application widget that provides an interactive window for a user to perform operations, such as playing audio, taking photos, and making calls. Each activity may obtain a window used to draw a user interface. A window may occupy an entire screen of the electronic device 100, or may be smaller than a screen of the electronic device 100, or may float above another window. In other words, the activity may be a visual interface or a view interface of a user operation. Each user interface of an application is an activity, and different user interfaces are different activities. One application may include one or more activities. For example, an audio/video playing interface of the multimedia application is an activity, and a comment viewing interface is another activity.

The Android runtime includes a core library and a virtual machine. The Android runtime is responsible for scheduling and management of the Android system.

The core library includes two parts: a function that needs to be invoked in Java language and a core library of Android.

The application layer and the application framework layer run on the virtual machine. The virtual machine executes java files of the application layer and the application framework layer as binary files. The virtual machine is configured to implement functions such as object lifecycle management, stack management, thread management, security and exception management, and garbage collection.

The system library may include a plurality of functional modules, for example, a surface manager, a media library, a three-dimensional graphics processing library (for example, OpenGL ES), and a 2D graphics engine (for example, SGL).

The surface manager is configured to manage a display subsystem and provide fusion of 2D and 3D layers for a plurality of applications.

The media library supports playback and recording in a plurality of commonly used audio/video formats, and static image files. The media library may support a plurality of audio/video coding formats, for example, MPEG-4, H.264, MP3, AAC, AMR, JPG, and PNG.

The three-dimensional graphics processing library is configured to implement three-dimensional graphics drawing, image rendering, composition, layer processing, and the like.

The 2D graphics engine is a drawing engine for 2D drawing.

The kernel layer is a layer between hardware and software. The kernel layer includes at least a display driver, a camera driver, an audio driver, and a sensor driver.

The software structure shown in FIG. 2A is merely an example for description of this disclosure, and should not constitute a limitation on this disclosure. In some embodiments, the electronic device 100 may further have more or fewer software modules than those shown in FIG. 2A, or combine some software modules, or split some software modules, or have software modules arranged at different positions.

FIG. 2B is a diagram of an example of another structure of the electronic device 100.

As shown in FIG. 2B, the electronic device 100 includes a multimedia application, a stuttering detection module, a human-machine interaction module, a network management module, and a multimedia processing module. For the multimedia application, refer to the description of the foregoing embodiment.

The human-machine interaction module may be configured to: perform interaction by a user with the electronic device 100, and determine, through a human-machine interaction interface, information exchanged between the user and the electronic device 100. For example, the human-machine interaction module may detect a user operation on the electronic device 100. The foregoing user operation may include but is not limited to: a touch operation (for example, a tap operation, a touch and hold operation, a swipe-up operation, and a swipe-down operation) acting on a screen of the electronic device 100, a mid-air gesture operation for the electronic device 100, and an operation for the electronic device 100 based on one or more input devices such as a mouse, a keyboard, and a stylus. A type of the user operation that can be detected by the human-machine interaction module is not limited in embodiments of this disclosure. For example, for the touch operation acting on the screen of the electronic device 100, the human-machine interaction module may detect information such as position coordinates and action time of the touch operation acting on the screen. A specific method for detecting the user operation by the human-machine interaction module is not limited in embodiments of this disclosure. The human-machine interaction module may also be referred to as a name like a user input module. In some embodiments, the human-machine interaction module may be located at the application framework layer shown in FIG. 2A.

The multimedia processing module may be configured to process and play multimedia content. The multimedia processing module may include an audio module and a video module. The audio module may include a software module that is located at the application framework layer and that is configured to manage or process an audio. Optionally, the audio module may further include a software program that is located at the application layer and that is used to manage or play an audio. The audio module may further include a hardware apparatus that is in the electronic device 100 and that is configured to play or process the audio, for example, the audio processing module 170, the speaker 170A, the receiver 170B, the microphone 170C, and the headset jack 170D that are shown in FIG. 1. Content of the audio module is not limited in embodiments of this disclosure.

The audio module may be configured to receive an audio event reported by one or more multimedia applications in the electronic device 100. For details about the audio event, refer to the preceding descriptions. The audio module may further receive audio data from the multimedia application, and play audio based on the audio data.

The video module may include a software module that is located at the application framework layer shown in FIG. 2A and that is configured to manage or process a video. Optionally, the video module may further include a software program that is located at the application layer and that is used to manage or play a video. The video module may further include a three-dimensional graphics processing library, a two-dimensional graphics engine, a media library, and the like that are located in the system library shown in FIG. 2A, to implement drawing and displaying of a video picture. The video module may further include a hardware apparatus that is in the electronic device 100 and that is configured to play or process a video. Content of the video module is not limited in embodiments of this disclosure.

The video module may be configured to receive a video event reported by one or more multimedia applications in the electronic device 100. The video module may further receive video data from the multimedia application, and play a video based on the video data. In some embodiments, for over preset duration after the video module receives an event indicating that playing of the video is started, if the video module has no video data that can be used for playing, the video module may generate a data timeout event of the video. Then, the video module may wait for subsequent playing data of the video. When video data is obtained again, the video module may generate a data resume event of the video.

The stuttering detection module may be configured to detect stuttering in playing of multimedia content. In some embodiments, the stuttering detection module may register user operation event monitoring and reporting with the human-machine interaction module. After detecting a user operation, the human-machine interaction module may send the user operation event to the stuttering detection module, to indicate, to the stuttering detection module, information about the user operation on the electronic device 100. The stuttering detection module may further register audio event monitoring and reporting with the audio module. After receiving the audio event reported by the multimedia application, the audio module may send the audio event to the stuttering detection module. In this way, the stuttering detection module may detect, based on the user operation event and the audio event, whether stuttering occurs in the audio currently played in the electronic device 100.

If no stuttering occurs in the audio, the stuttering detection module may continue to detect, and wait for a new user operation event and a new audio event.

If stuttering occurs in the audio, the stuttering detection module may indicate the network management module to adjust a network, so that the electronic device 100 uses a network with better quality to perform communication.

In some embodiments, the stuttering detection module may register video event monitoring and reporting with the video module. After receiving the video event reported by the multimedia application, the video module may send the video event to the stuttering detection module. In this way, the stuttering detection module may detect, based on the user operation event and the video event, whether stuttering occurs in a video currently played in the electronic device 100.

It can be learned that, the stuttering detection module may detect, from a system layer, whether stuttering occurs in playing of the multimedia content of any multimedia application in the electronic device 100. In this way, a developer of a multimedia application does not need to additionally perform an operation of detecting stuttering in playing of the multimedia content, thereby reducing development costs for the developer and improving development efficiency.

The network management module may be configured to manage a network accessed by the electronic device 100. In some embodiments, the network management module may adjust, by using one or more policies such as Wi-Fi and cellular switching, cellular cell handover, primary/secondary card switching, multi-network switching, multi-network concurrency, and Wi-Fi roaming, a network used by the electronic device 100 to perform data communication, so that the electronic device 100 performs communication by using a network with better quality.

The foregoing Wi-Fi and cellular switching may indicate that when the electronic device 100 accesses both a Wi-Fi network and a cellular mobile network, the network management module may switch, between the Wi-Fi network and the cellular mobile network based on quality of the Wi-Fi network and the cellular mobile network, the network used for data communication with another device. When the quality of the Wi-Fi network is better than the quality of the cellular mobile network, the network management module may adjust, to the Wi-Fi network, the network used by the electronic device 100 to perform data communication with the another device. When the quality of the cellular mobile network is better than the quality of the Wi-Fi network, the network management module may adjust, to the cellular network, the network used by the electronic device 100 to perform data communication with the another device.

The primary/secondary card switching may indicate that the electronic device 100 includes a primary SIM card and a secondary SIM card. The network management module may switch, between cellular mobile networks corresponding to the primary SIM card and the secondary SIM card, the network for performing data communication with the another device.

That the network management module adjusts, from one network to another network, the network used by the electronic device 100 to perform communication may include but is not limited to: adjusting from the Wi-Fi network to the cellular mobile network, adjusting from the cellular mobile network corresponding to the primary SIM card to the cellular mobile network corresponding to the secondary SIM card, adjusting from a cellular mobile network of one standard to a cellular mobile network of another standard (for example, from a 4G cellular mobile network to a 5G cellular mobile network), adjusting a cellular mobile network from one camping cell to another camping cell, and the like.

A method for adjusting, by the network management module, the network used by the electronic device 100 to perform communication is not limited in embodiments of this disclosure.

In some embodiments, both the stuttering detection module and the network management module may be located at the application framework layer shown in FIG. 2A.

In some embodiments, the stuttering detection module may further obtain information about an activity in the electronic device 100 from the activity manager shown in FIG. 2A, to determine whether the electronic device 100 currently includes an activity of a multimedia playing interface and whether the multimedia playing interface is currently displayed on a screen. The multimedia playing interface may be used to control playing of multimedia content. The multimedia playing interface may include a video playing interface and an audio playing interface. Some multimedia content is a combination of a video and an audio, and the video and the audio are played together. When the electronic device 100 plays the multimedia content, the electronic device 100 may play the audio associated with the video while displaying the video playing interface. Other multimedia content is an independent video, that is, the video is not associated with an audio. When the electronic device 100 plays the multimedia content, the electronic device 100 may display a video playing interface, and does not need to play an audio. Some audios exist independently and are not associated with videos. When the electronic device 100 plays the audios, the electronic device 100 may display an audio playing interface.

In some embodiments, the electronic device 100 may further include a process management module (not shown in FIG. 2B). The process management module may be configured to manage a process in the electronic device 100. The process management module may create a process, allocate a CPU time-slice resource to the process, manage a status of the process, and the like. The stuttering detection module may obtain, from the process management module, information about a process that is running in the electronic device 100, to determine whether the multimedia application in the electronic device 100 is in a running state and whether the multimedia application runs in the foreground or in the background.

The following describes a scenario of detecting stuttering in playing of multimedia content provided in this disclosure.

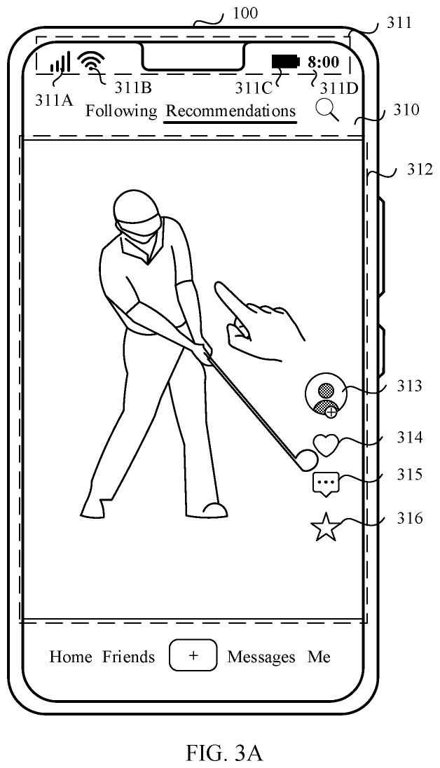

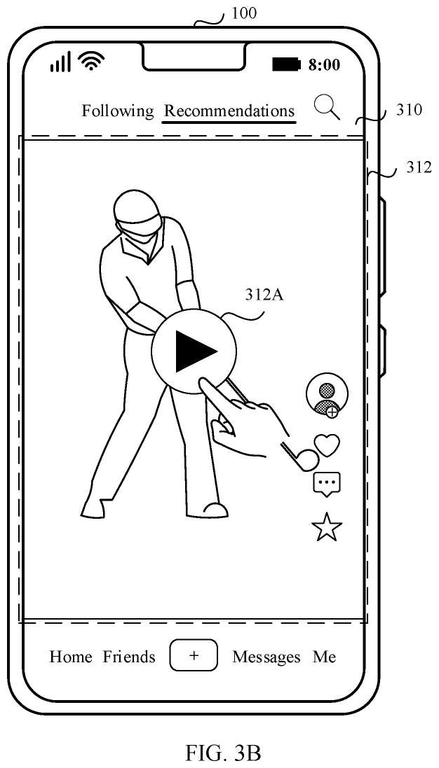

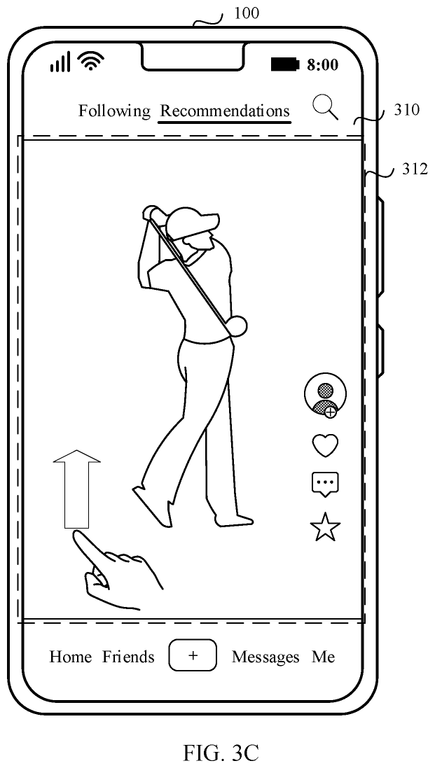

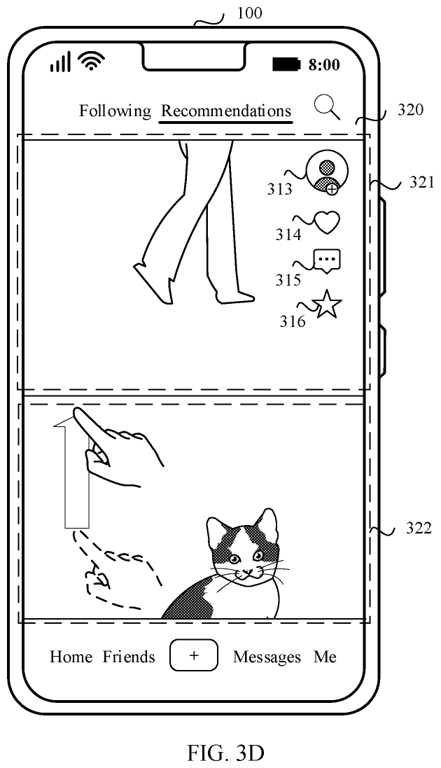

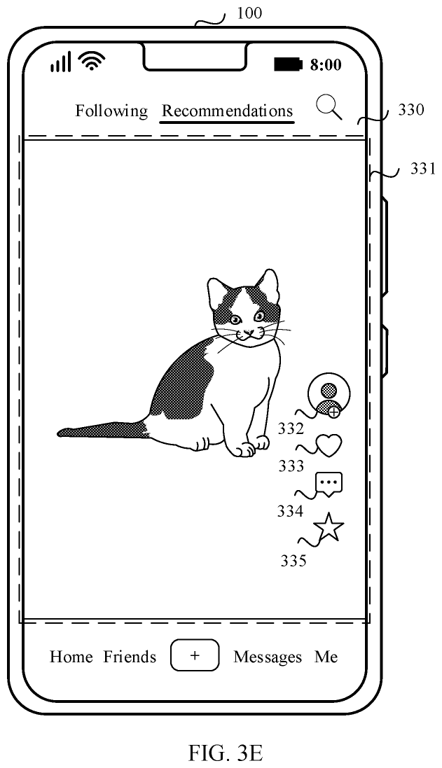

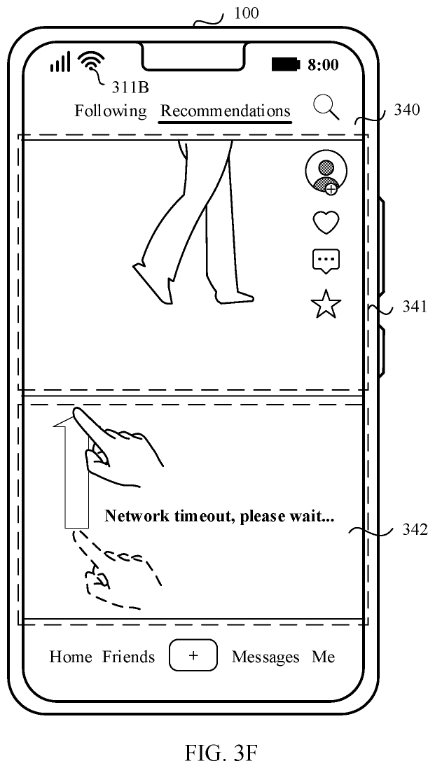

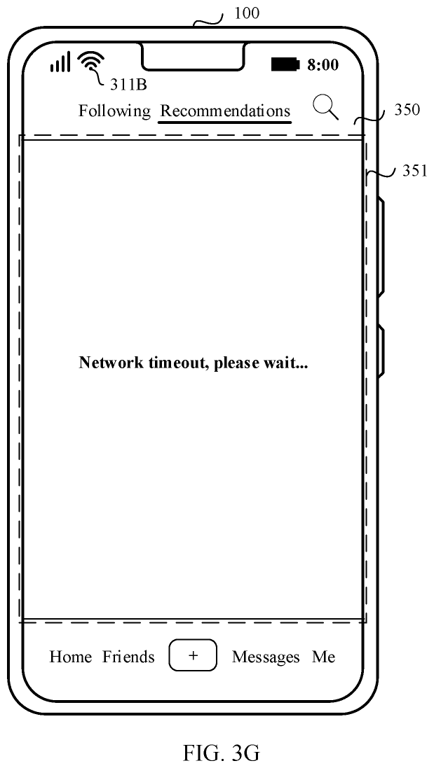

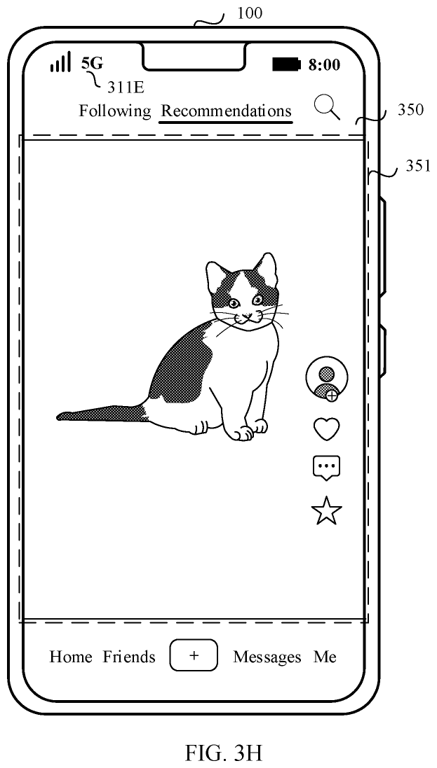

FIG. 3A to FIG. 3H show examples of diagrams of some scenarios of detecting stuttering in playing of multimedia content.

Herein, an example in which multimedia content is a combination of an audio and a video is used for description.

As shown in FIG. 3A, an electronic device 100 may display a user interface 310. The user interface 310 may be a multimedia playing interface (namely, an audio/video playing interface) of a multimedia application. The user interface 310 may include a status bar 311, a video display area 312, a follow control 313, a like control 314, a comment control 315, and a favorites control 316.

The status bar 311 may include a signal strength indicator 311A, a Wi-Fi indicator 311B, a power level indicator 311C, and time information 311D.

The signal strength indicator 311A may indicate signal strength of the cellular mobile network accessed by the electronic device 100. In some embodiments, the status bar 311 may include one or more signal strength indicators. For example, when the electronic device 100 includes two SIM cards, the electronic device 100 may display two signal strength indicators in the status bar 311. The two signal strength indicators may respectively indicate signal strength of cellular mobile networks accessed by the electronic device 100 through the two SIM cards.

The Wi-Fi indicator 311B may indicate that the electronic device 100 accesses a Wi-Fi network. In some embodiments, the status bar 311 displays both the signal strength indicator 311A and the Wi-Fi indicator 311B, which may indicate that the electronic device 100 currently performs data communication with another device by using the Wi-Fi network.

The power level indicator 311C may indicate a current power level of the electronic device 100.

The time information 311D may indicate current time.

The video display area 312 may be used to display a video picture. When the video and the audio are combined, the video and the audio are integrated, and the electronic device 100 may synchronously play the audio and the video. In some embodiments, when stuttering occurs in the audio, stuttering also occurs in the video played synchronously with the audio also. That is, stuttering in the audio and the video occurs synchronously.

The follow control 313, the like control 314, the comment control 315, and the favorites control 316 may be displayed on the video picture. The follow control 313 may be used to follow a publisher of an audio/video in the video display area 312. The like control 314 may be used to like the audio/video played in the video display area 312. The comment control 315 may be used to invoke a comment interface, to comment on the audio/video played in the video display area 312. The favorites control 316 may be used to add the audio/video played in the video display area 312 to Favorites.

In a process of playing the audio/video shown in FIG. 3A, the electronic device 100 may play the audio/video while obtaining subsequent playing data of the audio and the video online by using a network (for example, the Wi-Fi network). The electronic device 100 may pre-cache playing data of the audio and the video in a subsequent period of time following a current playing position.

In response to a tap operation acting in the video display area 312 shown in FIG. 3A, the electronic device 100 may pause playing of the audio/video, and display the user interface 310 shown in FIG. 3B. The tap operation used to pause playing of the audio/video may be an operation acting at any position other than positions of the follow control 313, the like control 314, the comment control 315, and the favorites control 316 in the video display area 312.

As shown in FIG. 3B, when playing of the audio/video is paused, the electronic device 100 may display a play control 312A in the video display area 312. The play control 312A may indicate that the audio/video are currently in a playing pause state, and may be used to trigger the electronic device 100 to continue to play the audio/video. In some embodiments, triggering the electronic device 100 to continue to play the audio/video is not limited to performing an operation on the play control 312A. In the playing pause state of the audio/video, the electronic device 100 may continue to play the audio/video in response to a tap operation acting at any position other than a position of a function control (for example, the follow control 313, the like control 314, the comment control 315, or the favorites control 316) in the video display area 312.

In response to the operation of pausing playing the audio/video shown in FIG. 3A, the multimedia application in the electronic device 100 may report a pause event to the audio module, and the user interaction module may send, to the stuttering detection module, a user operation event corresponding to the operation. The user operation event may include information such as an action position and action time of the operation on the screen. The audio module may further send the pause event to the stuttering detection module. The stuttering detection module may record the user operation event and the pause event. Optionally, when playing of the audio/video is paused, the multimedia application may also report, to the video module, the pause event indicating that playing of the video is paused. Then, the video module may send the pause event to the stuttering detection module.

In some embodiments, the stuttering detection module in the electronic device 100 may identify a user operation based on a received user operation event, and determine whether the user operation is a preset operation. For example, the preset operation includes a swipe-up operation and a swipe-down operation, but does not include a tap operation. The stuttering detection module may identify, based on the user operation event, that the user operation shown in FIG. 3A is a tap operation. The stuttering detection module may determine that the tap operation is not the preset operation. When the user operation indicated by the user operation event is not the preset operation, the stuttering detection module may continue to wait for a new user operation event and a new audio event.

As shown in FIG. 3B, when the audio/video are in the playing pause state, in response to the tap operation on the play control 312A, the electronic device 100 may continue to play the audio/video, and display the user interface 310 shown in FIG. 3C.

As shown in FIG. 3C, the electronic device 100 may display, in the video display area 312, a video picture of continued playing of the video, and continue to play the audio associated with the video. In response to an operation of playing an audio shown in FIG. 3B, the multimedia application in the electronic device 100 may report a start event to the audio module, and the user interaction module may send, to the stuttering detection module, a user operation event corresponding to the operation. The audio module may further send the start event to the stuttering detection module. It should be noted that the start event may be reported by the multimedia application after obtaining playing data that starts from a playing continue position of the audio/video corresponding to content displayed in the video display area 312.

The stuttering detection module may record the user operation event and the start event. The stuttering detection module may identify, based on the user operation event, that the user operation shown in FIG. 3B is a tap operation, and determine that the tap operation is not the preset operation.

When the electronic device 100 plays one audio/video, the electronic device 100 may switch to play another audio/video based on a user operation.

As shown in FIG. 3C, in response to a swipe-up operation acting on the video display area 312, the electronic device 100 may display a user interface 320 shown in FIG. 3D. The user interface 320 may be an audio/video playing interface displayed by the electronic device 100 in a process in which the swipe-up operation is performed.

As shown in FIG. 3D, the user interface 320 may include a video picture 321 and a video picture 322. The video picture 321 and the video picture 322 may be video pictures corresponding to different audios/videos. The video picture 321 may be a video picture displayed in the video display area 312 shown in FIG. 3C.

In a process in which a finger of a user gradually swipes up, the electronic device 100 may gradually move the video picture 321 and the video picture 322 up. The video picture 321 gradually moves up, and content that is on the top of the video picture 321 and that is out of the display area is hidden. The video picture 322 gradually moves up, and the originally hidden content at the bottom of the video picture 321 is gradually displayed. That is, as the finger of the user swipes up, less content of the video picture 321 is displayed on the screen, the video picture 321 occupies a smaller display area, more content of the video picture 322 is displayed on the screen, and the video picture 322 occupies a larger display area.

In some embodiments, when a display area occupied by the video picture 322 exceeds a preset area size, when the swipe-up operation ends (that is, the finger that performs the swipe-up operation leaves the screen), the electronic device 100 may switch to play an audio/video corresponding to the video picture 322, and display the user interface 330 shown in FIG. 3E.

In some embodiments, the audio/video corresponding to the video picture 322 are a next to-be-played audio/video of an audio/video corresponding to the video picture 321. The electronic device 100 may pre-obtain and cache playing data of the audio/video corresponding to the video picture 322. For example, based on a caching technology, when the audio/video corresponding to the video picture 321 is played, in addition to all playing data of the audio/video corresponding to the video picture 321, data obtained online by the electronic device 100 by using the network may further include a part or all of playing data of a subsequent audio/video (namely, the audio/video corresponding to the video picture 322). Alternatively, the electronic device 100 may obtain, online by using the network in response to the swipe-up operation shown in FIG. 3C, the playing data of the audio/video corresponding to the video picture 322. The electronic device 100 may start to obtain the playing data of the audio/video corresponding to the video picture 322 in a process of the swipe-up operation, or may start to obtain the playing data of the audio/video corresponding to the video picture 322 after the swipe-up operation is completed.

In response to the swipe-up operation shown in FIG. 3C and FIG. 3D, the multimedia application in the electronic device 100 may report a stop event and a start event to the audio module, and the user interaction module may send, to the stuttering detection module, a user operation event corresponding to the swipe-up operation. The audio module may further send the stop event and the start event to the stuttering detection module. The stop event may indicate that playing of the audio/video corresponding to the video picture 321 stops. The start event may indicate that playing of the audio/video corresponding to the video picture 322 is started. It should be noted that the start event may be reported by the multimedia application when the multimedia application obtains the playing data of the audio/video corresponding to the video picture 322. That is, when the audio/video corresponding to the video picture 322 need to be played, the multimedia application reports the start event only when there is playing data that can be used for playing of the audio/video corresponding to the video picture 322. If the audio/video corresponding to the video picture 322 need to be played, but the multimedia application does not obtain the playing data of the audio/video corresponding to the video picture 322, the multimedia application does not report the start event.

After receiving the user operation event corresponding to the swipe-up operation, the stuttering detection module may determine, based on the user operation event, that the user operation is the swipe-up operation, and determine that the user operation shown in FIG. 3C and FIG. 3D is the preset operation. When detecting the preset operation, the stuttering detection module may detect whether the start event is received within a preset time period starting from action time of the preset operation. A value of the preset time period may be 2s, 3s, or the like. Duration of the preset time period is not limited in embodiments of this disclosure. If the stuttering detection module receives the start event within the preset time period, the stuttering detection module may continue to wait for a new user operation event and a new audio event. If the stuttering detection module does not receive the start event within the preset time period, the stuttering detection module may indicate the network management module in the electronic device 100 to adjust a network, so that the electronic device 100 uses a network with better quality to perform communication. In this way, the electronic device 100 may obtain the playing data of the audio/video corresponding to the video picture 322 as soon as possible, to eliminate stuttering in the audio/video.

FIG. 3D and FIG. 3E show an example of a scenario in which during audio/video switching, no stuttering occurs in an audio/video to be played after the switching. In response to the swipe-up operation shown in FIG. 3C and FIG. 3D, the multimedia application can quickly obtain playing data of a subsequent audio/video to be played after switching, to play the audio/video after the switching based on the playing data, and display the video picture 322 shown in FIG. 3D and a video display area 331 shown in FIG. 3E.

As shown in FIG. 3E, the user interface 330 may include the video display area 331, a follow control 332, a like control 333, a comment control 334, and a favorites control 335. A video picture displayed in the video display area 331 is a complete picture of the video picture 322 shown in FIG. 3D. An audio/video corresponding to the video picture in the video display area 331 may be a subsequent to-be-played audio/video of the audio/video corresponding to the video picture in the video display area 312 shown in FIG. 3C. The follow control 332 may be used to follow a publisher of an audio/video in the video display area 331. The like control 333 may be used to like the audio/video played in the video display area 331. The comment control 334 may be used to invoke a comment interface, to comment on the audio/video played in the video display area 331. The favorites control 335 may be used to add the audio/video played in the video display area 331 to Favorites.

In some embodiments, during audio/video switching, stuttering may occur in an audio/video to be played after switching.

FIG. 3F to FIG. 3H show an example of a scenario in which during audio/video switching, stuttering occurs in an audio/video played after the switching.

For example, in a process of playing the audio/video shown in FIG. 3C, in response to the swipe-up operation, if the electronic device 100 cannot obtain playing data of a subsequent to-be-played audio/video due to a reason like a poor network, the electronic device 100 may display a user interface 340 shown in FIG. 3F. The user interface 340 may be an audio/video playing interface displayed by the electronic device 100 in a process in which the swipe-up operation is performed.

As shown in FIG. 3F, the user interface 340 may include a video picture 341 and a display area 342. For the video picture 341, refer to the video picture 321 shown in FIG. 3D. The display area 342 may be used to play a subsequent to-be-played audio/video of the audio/video corresponding to the video picture 341. Because the electronic device 100 does not obtain playing data of the subsequent to-be-played audio/video, the electronic device 100 may display, in the display area 342, prompt information shown in FIG. 3F. For example, content of the prompt information may be “Network timeout, please wait . . . ”. The prompt information may indicate that stuttering occurs in the subsequent to-be-played audio/video. The content of the prompt information is not limited in this disclosure.

When the swipe-up operation ends, the electronic device 100 may display a user interface 350 shown in FIG. 3G. The user interface 350 may include a video display area 351. Because the electronic device 100 does not obtain the playing data of the to-be-played audio/video, the electronic device 100 may display the prompt information in the video display area 351. For the prompt information, refer to the prompt information in the display area 342 shown in FIG. 3F.

In response to the swipe-up operation shown in FIG. 3C and FIG. 3F, the user interaction module in the electronic device 100 may send, to the stuttering detection module, a user operation event corresponding to the swipe-up operation. The stuttering detection module may determine, based on the user operation event, that the user operation is the swipe-up operation, and determine that the user operation shown in FIG. 3C and FIG. 3F is the preset operation. When detecting the preset operation, the stuttering detection module may detect whether the start event is received within a preset time period starting from action time of the preset operation. Because the multimedia application does not obtain the playing data of the subsequent to-be-played audio/video in time, the stuttering detection module does not receive the start event within the preset time period. The stuttering detection module may determine stuttering in playing of the multimedia content, to indicate the network management module to adjust the network.

For example, the network management module may adjust, from a Wi-Fi network to a cellular mobile network, a network used by the electronic device 100 to perform data communication with another device.

As shown in FIG. 3G, a Wi-Fi indicator 311B may be displayed on a user interface 350. The Wi-Fi indicator 311B may indicate that the network currently used by the electronic device 100 to perform data communication with the another device is a Wi-Fi network. When the Wi-Fi network is used, the multimedia application cannot obtain the playing data of the subsequent to-be-played audio/video in time. The network management module may search for, based on an indication of adjusting the network by the stuttering detection module, a network whose quality is better than that of the Wi-Fi network. When a cellular mobile network that is accessed by the electronic device 100 and whose quality is better than that of the Wi-Fi network is found, the network management module may adjust the network for performing data communication to the cellular mobile network.

In some embodiments, when the Wi-Fi network is adjusted to the cellular mobile network, the electronic device 100 may display a cellular mobile network indicator 311E shown in FIG. 3H. The cellular mobile network indicator 311E may indicate that a network currently used by the electronic device 100 to perform data communication with another device is a cellular mobile network. The electronic device 100 may communicate with another device (for example, an audio/video server) by using the cellular mobile network, to obtain playing data of a to-be-played audio/video online. When obtaining the playing data, the electronic device 100 may play an audio/video based on the playing data, and display, in the video display area 351, a video picture shown in FIG. 3H. After obtaining the playing data of the to-be-played audio/video, the multimedia application in the electronic device 100 may report the start event to the audio module. Then, the audio module may send the start event to the stuttering detection module.

In some embodiments, after determining stuttering in playing of the multimedia content, the stuttering detection module may indicate the network management module to adjust the network. When receiving the start event, the stuttering detection module may stop indicating the network management module to adjust the network.

The network adjustment scenarios shown in FIG. 3F to FIG. 3H are merely examples for description of this disclosure, and should not constitute a limitation on this disclosure. The network management module may further adjust, by using another method, the network used by the electronic device 100 to perform communication.

It should be noted that, in the foregoing scenarios shown in FIG. 3A to FIG. 3H, an example in which the swipe-up operation is the preset operation, and the tap operation is not the preset operation is used to describe a process of detecting stuttering in playing of the multimedia content. A type of the preset operation is not limited in embodiments of this disclosure. In some embodiments, the tap operation may also be the preset operation. A standard for setting the preset operation may include: setting one or more operations that can trigger the multimedia application to play an audio as the preset operation.

It can be learned from the scenarios shown in FIG. 3A to FIG. 3H that, in response to the preset operation used to trigger playing of the multimedia content, the multimedia application in the electronic device 100 reports the start event when playing data of to-be-played multimedia content can be used for playing. If the multimedia application does not report the start event in time after the electronic device 100 receives the preset operation, it may indicate that the multimedia application does not obtain the playing data of the to-be-played multimedia content, and stuttering occurs in playing of the multimedia content. Therefore, in this disclosure, the stuttering detection module may be used to detect whether the start event is received within the preset time period after the preset operation acts, to accurately detect whether stuttering occurs in the to-be-played multimedia content in the scenario in which playing of the multimedia content is triggered through the preset operation.

In some embodiments, the stuttering detection module may further determine, with reference to a playing status of the multimedia content, and a type and an action position of a user operation, whether to wait for the start event to detect stuttering in playing of the multimedia content. The following uses a tap operation as an example. There may be a plurality of function controls on a multimedia playing interface. Tap operations acting at different positions on the multimedia playing interface may have different purposes. In addition, when the multimedia content is in different playing statuses, tap operations acting at a same position on the multimedia playing interface may have different purposes.

For example, on the audio/video playing interface shown in FIG. 3A, a tap operation acting in an area other than a position of a function control (for example, the follow control 313, the like control 314, the comment control 315, and the favorites control 316) in the video display area 312 may be used to play or pause playing an audio/video. When the audio/video is in a playing state, a tap operation acting in the area other than the position of the function control in the video display area 312 may be used to pause playing the audio/video. When the audio/video is in a playing pause state, a tap operation acting in the area other than the position of the function control in the video display area 312 may be used to play the audio/video.

When playing of the audio is paused, the multimedia application can report the pause event. After the pause event is received, if the stuttering detection module determines, based on the received user operation event, that the user operation is a tap operation acting in the preset area on the screen, the stuttering detection module may detect whether the start event is received within the preset time period starting from action time of the tap operation. For example, the preset area may be an area other than positions of the function controls in the video display area 312 shown in FIG. 3A. If the stuttering detection module receives the start event within the preset time period starting from the action time of the tap operation, no stuttering occurs in the audio, and the stuttering detection module may continue to wait for a new user operation event and a new audio event. If the stuttering detection module does not receive the start event within the preset time period starting from the action time of the tap operation, stuttering occurs in the audio, and the stuttering detection module may indicate the network management module to adjust the network, so that the electronic device 100 performs communication by using a network with better quality.

The preset area may be determined based on the audio/video playing interface. Different audio/video playing interfaces may correspond to different preset areas. The electronic device 100 may determine, based on whether a user operation acts in a preset area on an audio/video playing interface, whether the user operation is an operation for triggering playing of the audio.

In the foregoing embodiment, the electronic device 100 can accurately detect whether stuttering occurs in the to-be-played multimedia content in the scenario in which playing of the audio is triggered through the swipe-up operation or the swipe-down operation, and can accurately detect whether stuttering occurs in the to-be-played multimedia content in the scenario in which playing of the multimedia content is triggered through the tap operation.

In the foregoing embodiment, with reference to the playing status of the multimedia content, and the type and the action position of the user operation, the user operation used to trigger playing of the multimedia content can be identified accurately, so that whether stuttering occurs in the to-be-played multimedia content can be detected in more scenarios in which playing of the multimedia content is triggered through the user operation.

In some embodiments, in addition to detecting whether stuttering occurs in the multimedia content when playing of the multimedia content is triggered, the stuttering detection module may further detect whether stuttering occurs in the multimedia content during playing of the multimedia content.

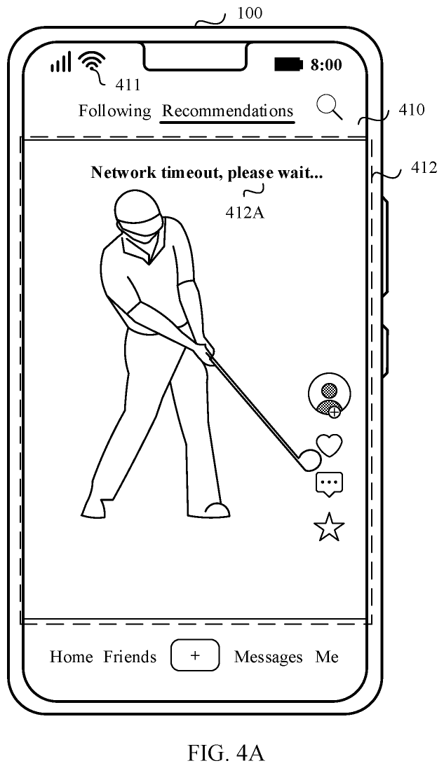

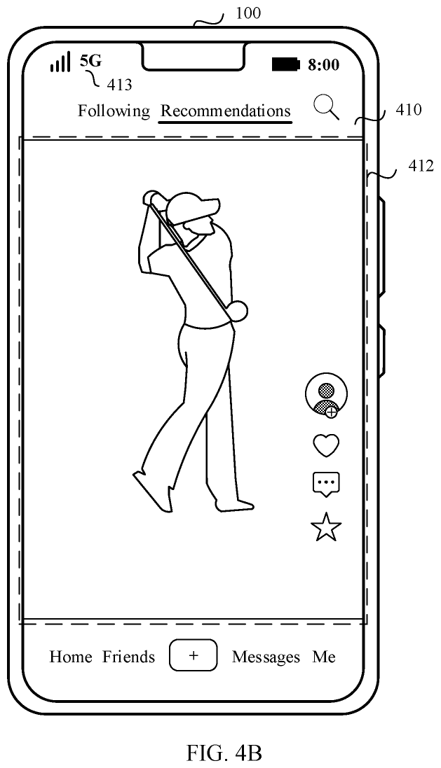

FIG. 4A and FIG. 4B are diagrams of some other scenarios of detecting stuttering in playing of multimedia content.

As shown in FIG. 4A, an electronic device 100 may display a user interface 410. The user interface 410 may be an audio/video playing interface of a multimedia application. The user interface 410 may include a Wi-Fi indicator 411 and a video display area 412. The Wi-Fi indicator 411 may indicate that a network currently used by the electronic device 100 to perform data communication with another device is a Wi-Fi network. The video display area 412 may display a video picture.

Herein, an example in which multimedia content played by the electronic device 100 is a combination of an audio and a video is still used for description. The electronic device 100 may synchronously play a video and an audio associated with the video. That is, when displaying a video picture in the video display area 412 shown in FIG. 4A, the electronic device 100 further plays the audio.

When playing of the audio/video starts, a multimedia application in the electronic device 100 may report a start event. A stuttering detection module may receive the start event. The electronic device 100 may obtain subsequent playing data while playing a corresponding video and audio based on obtained playing data of a to-be-played audio/video. In a process of playing an audio/video, if playing based on the obtained playing data by the electronic device 100 ends, but the electronic device 100 has not obtained subsequent playing data, the electronic device 100 currently has no playing data that can be used to play an audio/video. In this case, stuttering occurs in the audio/video. The electronic device 100 may display, in the video display area 412, prompt information 412A shown in FIG. 4A. Content of the prompt information 412A may include “Network timeout, please wait . . . ”. The prompt information 412A may be used to prompt a user that stuttering occurs in the audio/video. The content of the prompt information 412A is not limited in this disclosure.

In addition, for over preset duration, if no playing data is available for playing an audio/video, an audio module may generate a timeout event, and send the timeout event to the stuttering detection module. When the timeout event is received, the stuttering detection module may determine that stuttering occurs in the audio, and then indicate a network management module to adjust the network, so that the electronic device 100 uses a network with better quality to perform communication.

For example, the network management module may adjust, from the Wi-Fi network to a cellular mobile network, the network used by the electronic device 100 to perform data communication with another device.

As shown in FIG. 4B, the electronic device 100 may display a cellular mobile network indicator 413. The cellular mobile network indicator 413 may indicate that the network currently used by the electronic device 100 to perform data communication with another device is a cellular mobile network. The electronic device 100 may communicate with another device (for example, an audio/video server) by using the cellular mobile network, to obtain playing data of a to-be-played audio/video online. When obtaining the playing data, the electronic device 100 may resume playing of the audio/video based on the playing data, and display, in the video display area 412, a video picture shown in FIG. 4B. In this way, stuttering in the audio/video is eliminated. After obtaining the playing data of the to-be-played audio/video, the multimedia application in the electronic device 100 may send the playing data to the audio module. After receiving the playing data, the audio module may generate a resume event, and send the resume event to the stuttering detection module.

In some embodiments, after the timeout event is received and before the resume event is received, the stuttering detection module may indicate the network management module to adjust, for one or more times, the network used by the electronic device 100 to perform communication. For example, when the timeout event is received, the stuttering detection module may indicate, for a first time, the network management module to adjust the network used by the electronic device 100 to perform communication. After indicating the network management module to adjust the network used by the electronic device 100 to perform communication, the stuttering detection module may wait for the resume event within a preset time period. If not receiving the resume event within the preset time period after indicating the network management module to adjust the network used by the electronic device 100 to perform communication, the stuttering detection module may indicate the network management module again to adjust the network used by the electronic device 100 to perform communication. The stuttering detection module may indicate, according to the foregoing method, the network management module for a plurality of times to adjust the network used by the electronic device 100 to perform communication until the resume event is received.

It may be understood that after the network management module adjusts the network based on an indication of the stuttering detection module once, an adjusted network may still be poor. Based on the adjusted network, the electronic device 100 may still fail to communicate with a device like an audio/video server to obtain the playing data of the to-be-played audio/video. In this case, the audio module cannot generate the resume event in time. The stuttering detection module may indicate the network management module again to adjust the network used by the electronic device 100 to perform communication. Then, the network management module may adjust the network again, so that the electronic device 100 uses a network with better quality to perform communication. For example, the network management module may first adjust, from the Wi-Fi network to the cellular mobile network, the network used by the electronic device 100 to perform data communication with another device. When again receiving an indication of adjusting the network from the stuttering detection module, the network management module may use a policy such as cellular cell handover or primary/secondary card switching, so that the electronic device 100 uses a network with better quality to perform communication. In this way, it can be convenient for the electronic device 100 to obtain the playing data of the to-be-played audio/video as soon as possible, to eliminate stuttering in the audio/video.

It can be learned from the foregoing scenarios in FIG. 4A and FIG. 4B that the timeout event may reflect that stuttering occurs during playing of the audio. The electronic device 100 may accurately detect, based on the timeout event, whether stuttering occurs during playing of the audio, adjust the network when stuttering occurs in the audio, and perform communication by using a network with better quality to eliminate stuttering. In this way, audio listening experience of the user can be improved.

Based on the foregoing scenario of detecting stuttering in playing of the multimedia content, the following specifically describes a method for detecting stuttering in playing of the multimedia content in this disclosure. Herein, an example in which the electronic device detects stuttering in playing of the multimedia content based on a user operation event and an audio event is used for description.

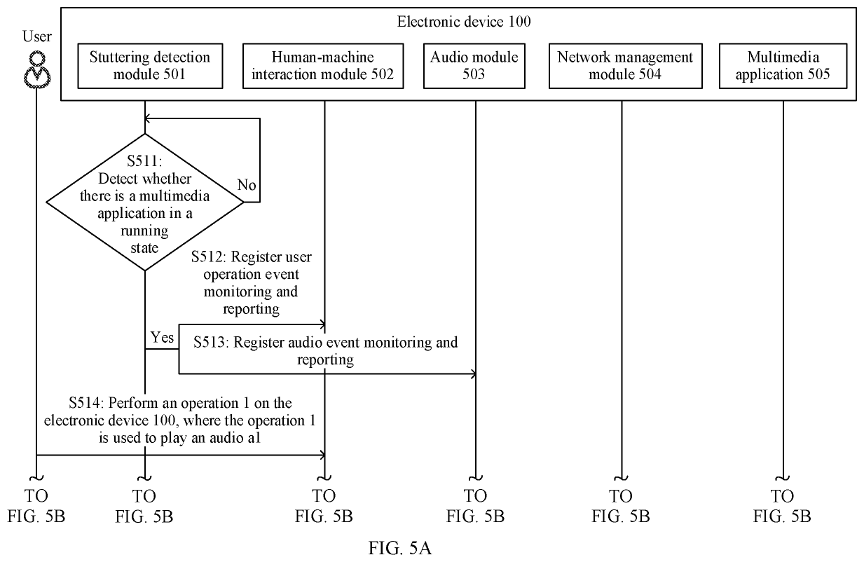

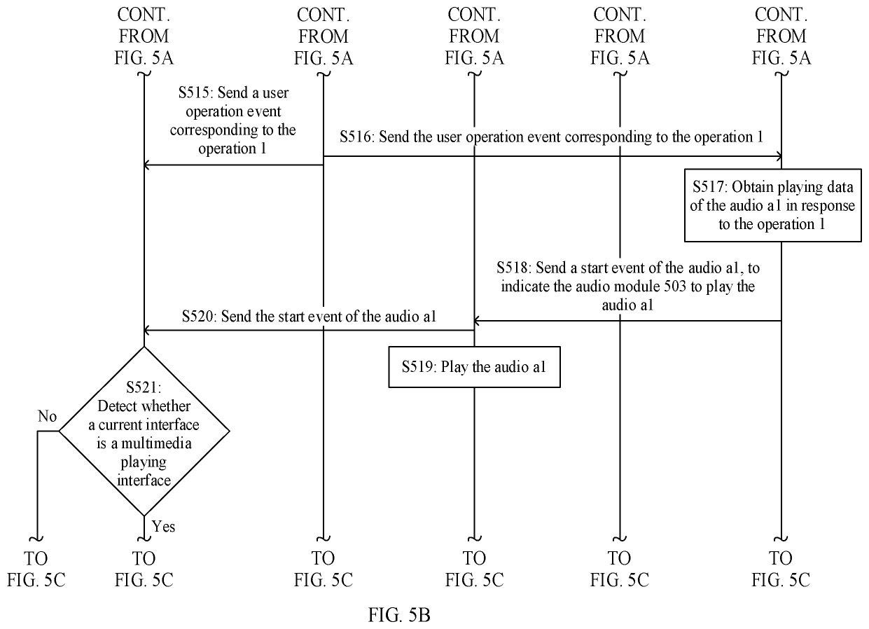

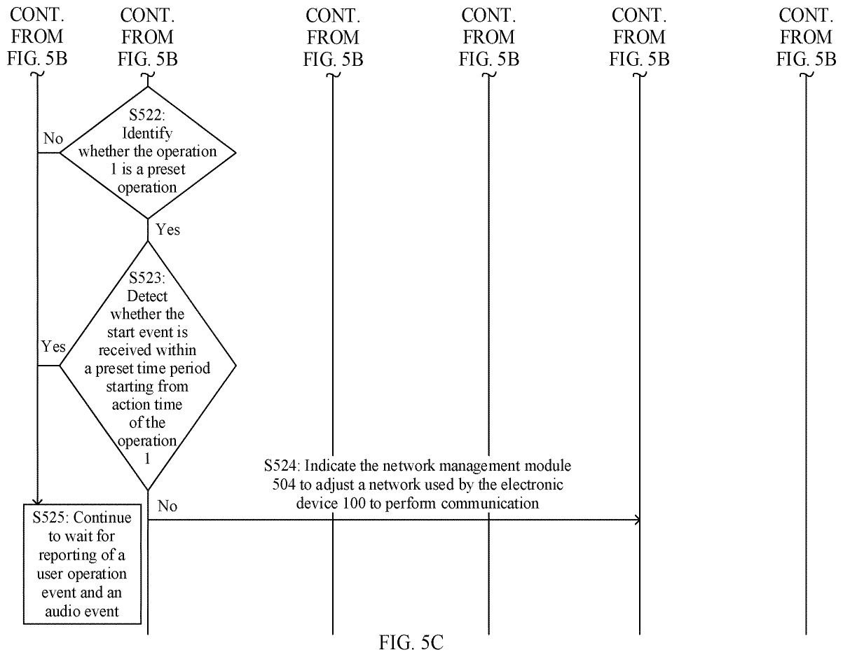

FIG. 5A to FIG. 5C show an example of a flowchart of a method for detecting stuttering in playing of multimedia content.

As shown in FIG. 5A to FIG. 5C, an electronic device 100 may include a stuttering detection module 501, a human-machine interaction module 502, an audio module 503, a network management module 504, and a multimedia application 505. For the stuttering detection module 501, the human-machine interaction module 502, the audio module 503, and the network management module 504, refer to the descriptions in FIG. 2B. The multimedia application 505 may be an app that is in the electronic device 100 and that plays multimedia content. This is not limited to the multimedia application 505. The electronic device 100 may further include more multimedia applications.

S511: The stuttering detection module 501 detects whether there is a multimedia application in a running state.

The electronic device 100 may simultaneously run a plurality of apps. Some apps may be in a foreground running state. Other apps may be in a background running state. When there is the multimedia application in the running state in the electronic device 100, the electronic device 100 may play multimedia content by using the app in the running state. Therefore, when there is the multimedia application in the running state, stuttering may occur in playing of the multimedia content in the electronic device 100. In this case, the electronic device 100 may detect, by using the stuttering detection module 501, whether stuttering occurs in playing of the multimedia content.

In some embodiments, the stuttering detection module 501 may detect, by obtaining process information in the electronic device 100, whether there is the multimedia application in the running state. A process can represent a running program in a system, and is an abstract of the running program. Each running program can form a process. If there is a process of a multimedia application (for example, the multimedia application 505) in the electronic device 100, the stuttering detection module 501 may determine that there is the multimedia application in the running state in the electronic device 100. The process may include a foreground process and a background process. The foreground process may include a process that is currently displayed on a screen and some system processes. The foreground process may be a process that is interacting with a user. The background process may include a process that is currently invisible to the user, that is, a process running in the background. The electronic device 100 may determine, based on whether the process of the multimedia application is a foreground process or a background process, whether the multimedia application runs in the foreground or in the background.

It is not limited to determining, based on the process, whether there is the multimedia application in the running state. The stuttering detection module 501 may further determine, by using another method, whether there is the multimedia application in the running state. A method for determining whether the multimedia application is in the running state is not limited in embodiments of this disclosure.

In some embodiments, when detecting that there is the multimedia application in the running state, the electronic device 100 may perform the following steps S512 and S513.

S512: The stuttering detection module 501 registers user operation event monitoring and reporting with the human-machine interaction module 502.

The human-machine interaction module 502 may be configured to detect a user operation on the electronic device 100. The human-machine interaction module 502 may accept registration, from another module or an application in the electronic device 100, for user operation event monitoring and reporting. When detecting the user operation, the human-machine interaction module 502 may send the user operation event to software or the application that has registered user operation event monitoring and reporting.

The stuttering detection module 501 registers user operation event monitoring and reporting with the human-machine interaction module 502, and may obtain information about the user operation received by the electronic device 100.

S513: The stuttering detection module 501 registers audio event monitoring and reporting with the audio module 503.

The audio module 503 may receive an audio event reported by the multimedia application, and send the audio event to another module or an application that has registered audio event reporting with the audio module 503.

The stuttering detection module 501 registers audio event monitoring and reporting with the audio module 503, and may obtain a playing status of an audio.

In some embodiments, this is not limited to detecting the multimedia application. When detecting that there is at least one app in the running state in the electronic device 100, the stuttering detection module 501 may perform steps S512 and S513. The app may be any app.

In some embodiments, in step S511, when detecting that there is no multimedia application in the running state, the electronic device 100 may cyclically perform step S511, to wait for the electronic device 100 to run at least one multimedia application.

Step S511 may be optional. For example, after the electronic device 100 is powered on and a system is started, the stuttering detection module 501 may perform steps S512 and S513. That is, the stuttering detection module 501 may not need to detect whether there is a multimedia application running in the electronic device 100.

S514: The user performs an operation 1 on the electronic device 100, where the operation 1 is used to play an audio a1.

In some embodiments, the operation 1 may be an operation of switching an audio a2 to the audio a1 when the electronic device 100 plays the audio a2. For the operation 1, refer to the swipe-up operation shown in FIG. 3D.

In some embodiments, the operation 1 may be an operation of triggering the electronic device 100 to continue to play the audio a1 when the audio a1 is in a playing pause state. For the operation 1, refer to the tap operation shown in FIG. 3B.

The operation 1 is not limited in embodiments of this disclosure.

Herein, an example in which the operation 1 is a user operation acting on a multimedia playing interface of the multimedia application 505 is used for description.

In some embodiments, the audio a1 may be associated with a video. When playing the audio a1, the electronic device 100 may synchronously play the video associated with the audio a1. That is, multimedia content played by the electronic device 100 is a combination of the audio a1 and the video. When playing the audio a1, the electronic device 100 may display a video picture on the multimedia playing interface displayed on the screen. Alternatively, the audio a1 is independent and is not associated with the video. The multimedia content played by the electronic device 100 is the independent audio a1. A type of the audio a1 is not limited in this disclosure.

The human-machine interaction module 502 may detect the operation 1, and perform the following steps S515 and S516.

S515: The human-machine interaction module 502 sends a user operation event corresponding to the operation 1 to the stuttering detection module 501.

S516: The human-machine interaction module 502 sends the user operation event corresponding to the operation 1 to the multimedia application 505.

The human-machine interaction module 502 may identify an app on which the operation 1 is performed in the electronic device 100. Because the operation 1 is the user operation acting on the multimedia playing interface of the multimedia application 505, the human-machine interaction module 502 may send the user operation event corresponding to the operation 1 to the multimedia application 505, so that the multimedia application 505 can perform a corresponding operation in response to the operation 1.

The user operation event corresponding to the operation 1 may include information such as a position at which the operation 1 acts on the screen and action time. The user operation event may be used to determine an operation type of the operation 1.

For example, the user operation event corresponding to the operation 1 may include: [InputEvent1: (x1, y1), 0-0-0, t1], and [InputEvent2: (x2, y2), 1-0-0, t2]. In InputEvent 1, 0-0-0 may represent finger pressing, (x1, y1) may represent coordinates of finger pressing on the screen in the operation 1, and t1 may represent a moment at which finger pressing is performed in the operation 1. In InputEvent2, 1-0-0 may represent finger releasing, (x2, y2) may represent coordinates of finger releasing from the screen in the operation 1, and t2 may represent a moment at which finger releasing is performed in the operation 1.

If a difference between x1 and x2 does not exceed a distance threshold, and a difference between y1 and y2 does not exceed the distance threshold, positions of finger pressing and finger releasing in the operation 1 are basically the same. The operation 1 is a tap operation or a touch and hold operation. Further, if a difference between t1 and t2 does not exceed a time threshold, the operation 1 is the tap operation. If the difference between t1 and t2 exceeds the time threshold, the operation 1 is the touch and hold operation.

If the difference between x1 and x2 does not exceed the distance threshold, and the difference between y1 and y2 exceeds the distance threshold, the operation 1 is a swipe-up operation or a swipe-down operation. Further, if y1 is greater than y2, the operation 1 may be the swipe-up operation. If y1 is less than y2, the operation 1 may be the swipe-down operation.

If the difference between x1 and x2 exceeds the distance threshold, and the difference between y1 and y2 does not exceed the distance threshold, the operation 1 is a swipe-left operation or a swipe-right operation. Further, if x1 is greater than x2, the operation 1 is the swipe-left operation. If x1 is less than x2, the operation 1 is the swipe-right operation.

The content of the user operation event is merely an example for description of this disclosure, and should not constitute a limitation on this disclosure.

S517: The multimedia application 505 obtains playing data of the audio a1 in response to the operation 1.

The multimedia application 505 may identify a type of the operation 1 (for example, the operation 1 is the swipe-up operation) based on the user operation event corresponding to the operation 1. Then, the multimedia application 505 may determine that the operation 1 is used to play the audio a1. The multimedia application 505 may obtain the playing data of the audio a1.

In some embodiments, before operation 1, the electronic device 100 obtains and caches the playing data of the audio a1. The multimedia application 505 may directly read the playing data of the audio a1 from a memory and use the playing data for playing.

In some other embodiments, the electronic device 100 does not store the playing data used to play the audio a1. The multimedia application 505 may communicate with a device like an audio/video server by using a network, and obtain the playing data of the audio a1 online.

A method for obtaining the playing data of the audio a1 by the multimedia application 505 is not limited in embodiments of this disclosure.

S518: The multimedia application 505 sends a start event of the audio a1 to the audio module 503, to indicate the audio module 503 to play the audio a1.

When obtaining the playing data used to play the audio a1, the multimedia application 505 may send the start event of the audio a1 to the audio module 503, to indicate the audio module 503 to play the audio a1. The multimedia application 505 may send the playing data of the audio a1 to the audio module 503.

S519: The audio module 503 plays the audio a1.

The audio module 503 may start to play the audio a1 based on the playing data of the audio a1.

S520: The audio module 503 sends the start event of the audio a1 to the stuttering detection module 501.

S521: The stuttering detection module 501 detects whether a current interface is a multimedia playing interface.

In some embodiments, after receiving the user operation event corresponding to the operation 1 (namely, step S515), the stuttering detection module 501 may detect whether the current interface is the multimedia playing interface, to determine whether the operation 1 is a user operation acting on the multimedia playing interface. The multimedia interface may be used to control playing of the multimedia content. For example, the multimedia playing interface may include but is not limited to a short video interface, a live video interface, and the like.

It may be understood that, if the operation 1 is an operation acting on the multimedia playing interface, the operation 1 may be used to control playing of the multimedia content. The stuttering detection module 501 may further determine, with reference to the information about the operation 1, whether it is necessary to wait for the start event. If the operation 1 is not an operation acting on the multimedia playing interface, there is a low probability that the operation 1 is used to control playing of an audio. To avoid incorrect detection of stuttering in the audio, after receiving the user operation event corresponding to the operation 1, the stuttering detection module 501 may not need to wait for the start event, and continue to wait for a new user operation event.

In some embodiments, the stuttering detection module 501 may obtain information about an activity corresponding to the current interface, and determine, based on the activity, whether the current interface is a multimedia playing interface. If the activity is an activity on the multimedia playing interface of the multimedia application 505, the current interface is the multimedia playing interface. If the activity is not an activity on the multimedia playing interface of the multimedia application 505, the current interface is not the multimedia playing interface. A method for detecting whether the current interface is the multimedia playing interface is not limited in embodiments of this disclosure.

If the current interface is the multimedia playing interface, the stuttering detection module 501 may perform the following step S522.

If the current interface is not the multimedia playing interface, the stuttering detection module 501 may perform the following step S525.

In some embodiments, step S521 may be performed before step S515.

S522: The stuttering detection module 501 identifies whether the operation 1 is a preset operation.

The preset operation may be an operation used to play multimedia content. For example, the preset operation may include the swipe-up operation.

It may be understood that, if the operation 1 is the preset operation used to play the multimedia content (for example, the audio), the multimedia application 505 needs to play the multimedia content in response to the operation 1, and the stuttering detection module 501 may wait for the start event to determine whether stuttering occurs in the multimedia content. If the operation 1 is not the preset operation, a probability that the multimedia application 505 reports the start event after the operation 1 is low. To avoid incorrect detection of stuttering in playing of the multimedia content, after receiving the user operation event corresponding to the operation 1, the stuttering detection module 501 may not need to wait for the start event, and continue to wait for a new user operation event.

In some embodiments, different multimedia applications may correspond to different preset operations. It may be understood that, in different multimedia applications, operations used to trigger playing of the multimedia content may be different. The electronic device 100 may store preset operations respectively corresponding to different multimedia applications. The stuttering detection module 501 may determine the preset operation based on an application to which the activity on the current interface belongs, to identify whether the operation 1 is the preset operation. In this way, targeted detection of stuttering in playing of the multimedia content can be performed when each multimedia application plays the multimedia content, thereby improving accuracy of detecting stuttering in playing of the multimedia content.

In some embodiments, the stuttering detection module 501 may further identify whether the operation 1 is a preset operation that acts when the multimedia content is in a preset playing status and that acts in a preset area on the screen. It may be understood that an operation may have different purposes when the multimedia content is in different playing statuses and/or when action positions are different. The stuttering detection module 501 may accurately identify, with reference to the playing status of the multimedia content, and the type and the action position of the user operation, the user operation used to trigger playing of the multimedia content, to detect, in more scenarios in which playing of the multimedia content is triggered through the user operation, whether stuttering occurs in to-be-played multimedia content.

If the operation 1 is the preset operation, the stuttering detection module 501 may perform the following step S523.

If the operation 1 is not the preset operation, the stuttering detection module 501 may perform the following step S525.

S523: The stuttering detection module 501 detects whether the start event is received within a preset time period starting from action time of the operation 1.

The stuttering detection module 501 may determine the action time of the operation 1 based on the user operation event corresponding to the operation 1. The action time of the operation 1 may be a moment at which the operation 1 ends (for example, a moment of finger releasing from the screen in the operation 1). Alternatively, the operation 1 continuously acts for a period of time. For example, operations such as the swipe-up operation and the touch and hold operation continuously act on the screen for a period of time. The stuttering detection module 501 may determine a moment in a process of performing the operation 1 as the action time of the operation 1. A manner of determining the action time of the operation 1 is not limited in this disclosure.

In some embodiments, the stuttering detection module 501 may set a timer based on the action time of the operation 1, and determine whether the start event is received before the timer expires. Timing duration of the timer may be duration of the preset time period, for example, 1 s or 2 s. A value of the timing duration is not limited in embodiments of this disclosure. The timer may start timing from the action time of the operation 1. The stuttering detection module 501 receives the start event before the timer expires, which may indicate that no stuttering occurs in playing of the multimedia content. The stuttering detection module 501 does not receive the start event before the timer expires, which may indicate that stuttering occurs in playing of the multimedia content.

It should be noted that sequence numbers of steps S521 to S523 and steps S517 to S520 do not constitute a limitation on an execution sequence of the steps. For example, steps S521 to S523 and steps S517 to S520 may be simultaneously performed. After receiving the user operation event corresponding to the operation 1, if the multimedia application 505 can quickly obtain the playing data of the audio a1, the multimedia application 505 may quickly report the start event. In this way, the stuttering detection module 501 may receive the start event before the timer expires. After receiving the user operation event corresponding to the operation 1, if the multimedia application 505 needs to wait for a long time to obtain the playing data of the audio a1 or cannot obtain the playing data of the audio a1 in time, time at which the multimedia application 505 reports the start event is late. In this way, the stuttering detection module 501 cannot receive the start event before the timer expires. The stuttering detection module 501 may accurately identify, with reference to the user operation event and the start event, whether stuttering occurs in the multimedia content.

If the stuttering detection module 501 receives the start event within the preset time period starting from the action time of the operation 1, the stuttering detection module 501 may perform the following step S525.

If the stuttering detection module 501 does not receive the start event within the preset time period starting from the action time of the operation 1, the stuttering detection module 501 may perform the following step S524.

S524: The stuttering detection module 501 indicates the network management module 504 to adjust a network used by the electronic device 100 to perform communication.

The network management module 504 may adjust, based on an indication of the stuttering detection module 501, the network used by the electronic device 100 to perform data communication with another device, so that the electronic device 100 uses a network with better quality to perform communication. In this way, the multimedia application 505 may obtain the playing data of the audio a1 as soon as possible, thereby eliminating stuttering and playing the audio a1.

S525: The stuttering detection module 501 continues to wait for reporting of a user operation event and an audio event.

When it is not determined whether the operation 1 is an operation of triggering playing of the multimedia content, the stuttering detection module 501 does not determine, when not receiving the start event within the preset time period starting from the action time of the operation 1, that stuttering occurs in the multimedia content, but continues to wait for a subsequent user operation event and a subsequent audio event. In this way, cases of incorrect detection of stuttering in playing of the multimedia content can be reduced, and accuracy of detecting stuttering in playing of the multimedia content is improved.

When it is determined that the operation 1 is the operation of triggering playing of the multimedia content, if receiving the start event within the preset time period starting from the action time of the operation 1, the stuttering detection module 501 may determine that no stuttering occurs in playing of the multimedia content, and then continue to wait for a subsequent user operation event and a subsequent audio event. The stuttering detection module 501 may detect, based on steps S521 and S525, a user operation event and an audio event that are subsequently received, to identify a case of stuttering in playing of the multimedia content.

It can be learned from the method shown in FIG. 5A to FIG. 5C that, the stuttering detection module 501 may obtain the user operation event corresponding to the user operation on the electronic device 100, and determine whether the user operation is the preset operation used to trigger playing of the multimedia content. When detecting that the user operation is the preset operation used to trigger playing of the multimedia content, the stuttering detection module 501 may detect whether the start event is received within the preset time period after the preset operation acts, to accurately detect, in a scenario in which playing of the multimedia content is triggered through the preset operation, whether stuttering occurs in to-be-played multimedia content.

In some embodiments, the electronic device 100 may detect stuttering in playing of the multimedia content based on the user operation event and a video event. The stuttering detection module 501 may register video event monitoring and reporting with a video module in the electronic device 100. When a playing status of a video changes, the multimedia application 505 may report a corresponding video event to the video module. Then, the video module may send the video event to the stuttering detection module 501.

For example, the human-machine interaction module 502 may send, to the stuttering detection module 501, a user operation event corresponding to an operation that acts on a multimedia playing interface of the multimedia application 505 and that is used to play a video. After determining, based on the user operation event, that the operation is the preset operation that acts on the multimedia playing interface and that is used to play the video, the stuttering detection module 501 may detect whether the playing start event of the video is received within the preset time period starting from the action time of the operation. For details of the foregoing process, refer to steps S521 to S523 shown in FIG. 5B and FIG. 5C.

In response to the operation that acts on the multimedia playing interface of the multimedia application 505 and that is used to play the video, after obtaining playing data of the to-be-played video, the multimedia application 505 may report the playing start event of the to-be-played video to the video module. The video module may send the playing start event to the stuttering detection module 501. If the stuttering detection module 501 receives the playing start event of the to-be-played video within the preset time period starting from the action time of the operation used to play the video, no stuttering occurs in playing of the multimedia content (namely, the to-be-played video). If the stuttering detection module 501 does not receive the playing start event of the to-be-played video within the preset time period starting from the action time of the operation used to play the video, the stuttering detection module 501 determines that stuttering occurs in playing of the multimedia content, and may indicate the network management module 504 to adjust the network used by the electronic device 100 to perform communication.

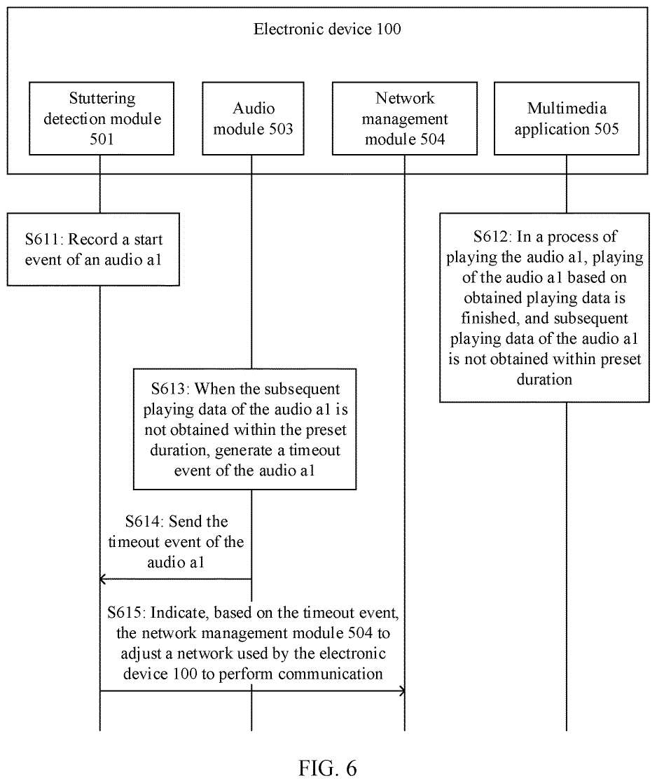

FIG. 6 is an example of a flowchart of another method for detecting stuttering in playing of multimedia content.

As shown in FIG. 6, the method may include steps S611 to S615.

S611: The stuttering detection module 501 records a start event of an audio a1.

It can be learned from the method shown in FIG. 5A to FIG. 5C that, when the electronic device 100 is triggered to play the audio a1, the audio module 503 may forward the start event reported by the multimedia application 505 to the stuttering detection module 501. The stuttering detection module 501 may record the start event of the audio a1. When the stuttering detection module 501 records the start event, if the stuttering detection module 501 does not receive a pause event or a stop event of the audio a1, it may indicate that the audio a1 is in a playing state.

S612: In a process of playing the audio a1, the multimedia application 505 finishes playing the audio a1 based on obtained playing data, and does not obtain subsequent playing data of the audio a1 within preset duration.

When the playing data of the audio a1 is obtained by the electronic device 100 from another device by using a network, the electronic device 100 may play the audio a1 while obtaining the subsequent playing data of the audio a1 from the another device. The electronic device 100 may cache a part of subsequent playing data of the audio a1, and when a network is suddenly poor, the electronic device 100 can still continue playing in a period of time.

In some embodiments, when the network is poor for a long time, after playing, based on the cached playing data, of the audio a1 in the memory ends, if the electronic device 100 still does not obtain the subsequent playing data of the audio a1 from the another device, no playing data is available for the multimedia application 505. Stuttering occurs in the audio a1.

S613: When not obtaining the subsequent playing data of the audio a1 within the preset duration, the audio module 503 generates a timeout event of the audio a1.

It may be understood that the audio module 503 may obtain the playing data of the audio a1 from the multimedia application 505. It can be learned from the foregoing step S612 that the multimedia application 505 does not obtain the subsequent playing data of the audio a1 within the preset duration. Therefore, the audio module 503 may also fail to obtain the subsequent playing data of the audio a1 within the preset duration to continue to play the audio a1. When not obtaining the subsequent playing data of the audio a1 within the preset duration, the audio module 503 may generate the timeout event of the audio a1.

The timeout event of the audio a1 may indicate that stuttering occurs during playing of the audio a1.

S614: The audio module 503 sends the timeout event of the audio a1 to the stuttering detection module 501.

S615: The stuttering detection module 501 indicates, based on the timeout event, the network management module 504 to adjust a network used by the electronic device 100 to perform communication.

The network management module 504 may adjust, based on an indication of the stuttering detection module 501, the network used by the electronic device 100 to perform data communication with another device, so that the electronic device 100 uses a network with better quality to perform communication. In this way, the multimedia application 505 may obtain the playing data of the audio a1 as soon as possible, thereby eliminating stuttering and playing the audio a1.

It can be learned from the method shown in FIG. 6 that the timeout event may reflect that stuttering occurs during playing of the audio. The electronic device 100 may accurately detect, based on the timeout event, whether stuttering occurs during playing of an audio in any multimedia application, adjust the network when stuttering occurs in the audio, and perform communication by using a network with better quality, to eliminate stuttering. In this way, audio listening experience of the user can be improved.

For a method for detecting, by the electronic device 100, whether stuttering occurs during playing of a video, refer to the method for detecting, by the electronic device 100, whether stuttering occurs during playing of the audio shown in FIG. 6.

In some embodiments, the electronic device 100 may further detect, with reference to a user operation on the electronic device 100 and a data transmission indicator, whether stuttering occurs in multimedia content. The foregoing data transmission indicator may be used to evaluate network quality, and is an indicator that reflects network quality. For example, the data transmission indicator may include round-trip time (RTT). The RTT may refer to duration taken by a network request to travel from a start point to a destination and then back to the start point. The RTT can be used to diagnose a speed and reliability of a network connection. Larger RTT indicates poorer network quality. Specific content of the data transmission indicator is not limited in embodiments of this disclosure. For example, in addition to the RTT, the data transmission indicator may further include indicators for evaluating network quality, such as data traffic of data transmission and a packet interval size. Herein, the RTT is specifically used as an example for description.

When receiving a user operation that acts on an audio/video playing interface and that is used to trigger playing of the multimedia content, the electronic device 100 may detect RTT within a preset time period after the user operation acts. If the RTT within the preset time period indicates that network quality is poorer than preset network quality, the electronic device 100 may determine that stuttering occurs in the multimedia content, and adjust the network to use a network with better quality to perform communication.

If all pieces of RTT within the preset time period are greater than a preset RTT threshold, it may indicate that the network quality is poorer than the preset network quality. Alternatively, if an average value of pieces of RTT within the preset time period is greater than the preset RTT threshold, it may indicate that the network quality is poorer than the preset network quality. A method for determining, by the electronic device 100, whether the RTT within the preset time period indicates that the network quality is poorer than the preset network quality is not limited in this disclosure.

The user operation used to trigger playing of the multimedia content is not limited in this disclosure.

In some embodiments, the electronic device 100 may detect, with reference to the user operation on the electronic device 100, a multimedia playing event, and the data transmission indicator, whether stuttering occurs in the multimedia content. The data transmission indicator may improve a confidence level of a media content stuttering detection result. In addition, the data transmission indicator may be further used to determine whether stuttering in the multimedia content is caused by the network quality.

Specifically, when receiving the user operation that acts on the audio/video playing interface and that is used to trigger playing of the multimedia content, the electronic device 100 may obtain, after the user operation, the start event reported by the multimedia application that plays the multimedia content.

If obtaining the start event, the electronic device 100 may determine that no stuttering occurs in the multimedia content. When it is determined, based on the user operation and the multimedia playing event, that no stuttering occurs in the multimedia content, if the RTT is less than the preset RTT threshold, it may indicate that current network quality is good. This improves a confidence level of a detection result of no stuttering in the multimedia content.

If not obtaining the start event, the electronic device 100 may determine that stuttering occurs in the multimedia content. When it is determined, based on the user operation and the multimedia playing event, that stuttering occurs in the multimedia content, if the RTT is greater than the preset RTT threshold, it may indicate that the current network quality is poor. This improves a confidence level of a detection result of stuttering in the multimedia content.

When it is determined, based on the user operation and the multimedia playing event, that stuttering occurs in the multimedia content, if the RTT is less than the preset RTT threshold, it may indicate that the current network quality is good, and stuttering in the multimedia content is not caused by the poor network quality. It may be understood that, in addition to the poor network quality, stuttering in the multimedia content may be caused by another reason. For example, if a processor of the electronic device 100 is overloaded, and too many processes run in the background, stuttering may occur in the multimedia content Therefore, when the electronic device 100 determines, based on the user operation and the multimedia playing event, that stuttering occurs in the multimedia, and the RTT is less than the preset RTT threshold, the electronic device 100 may terminate one or more processes in the background, to reduce load of the processor, and does not need to adjust the network used by the electronic device 100 to perform communication.

This is not limited to detecting whether stuttering occurs in playing of the multimedia content. The electronic device 100 may further detect, with reference to the user operation on the electronic device 100 and the data transmission indicator, whether stuttering occurs in browsing of an interface. In some embodiments, in addition to playing an audio and/or a video and displaying an audio/video playing interface, the multimedia application may further display an image-text interface. The image-text interface may refer to a user interface on which a text and/or an image is displayed. The image-text interface may be a long page. The electronic device 100 may respond to a preset user operation (for example, a swipe-up operation or a swipe-down operation) to scroll up or down the image-text interface, to display content in different areas of the image-text interface on a screen. The electronic device 100 may further jump from one image-text interface to another image-text interface in response to a preset operation (for example, a swipe-left operation or a swipe-right operation). This is not limited to the multimedia application. The electronic device 100 may further include another app in which an image-text interface can be displayed, for example, a browser, a news app, a shopping app, or a reading app.

The electronic device 100 may detect whether stuttering occurs when the user browses image-text interfaces of these apps.

Specifically, when receiving a user operation that acts on the image-text interface and that is used to switch display content, the electronic device 100 may detect RTT within a preset time period after the user operation acts. If the RTT within the preset time period indicates that network quality is poorer than the preset network quality, the electronic device 100 may determine that stuttering occurs in browsing of the image-text interface, and adjust the network to use a network with better quality to perform communication.

The user operation used to adjust the display content may include but is not limited to: a user operation used to switch content in different areas of the image-text interface, a user operation used to jump between image-text interfaces, and the like. For example, the user operation used to switch the content in different areas of the image-text interface may include the swipe-up operation and the swipe-down operation. The user operation used to jump between image-text interfaces may include the swipe-left operation and the swipe-right operation.

It can be learned from the foregoing embodiment that, when the user operation acting on the interface is received, the electronic device 100 may determine whether the interface is a preset interface, and determine whether the user operation is a preset user operation. If the preset user operation acts on the preset interface, the electronic device 100 may detect RTT within the preset time period after the user operation acts. If the RTT within the preset time period indicates that network quality is poorer than the preset network quality, the electronic device 100 may determine that stuttering occurs in browsing of the interface, and adjust the network to use a network with better quality to perform communication. In this way, the electronic device 100 can obtain, as soon as possible by using the network with better quality, data required for a display interface, to eliminate stuttering in browsing of the interface as soon as possible, and improve user experience in browsing the interface.

In some embodiments, the electronic device 100 may store a correspondence table between the preset interface and the preset user operation, to detect whether a received user operation is the preset user operation acting on the preset interface. Optionally, the electronic device 100 may alternatively obtain the correspondence table between the preset interface and the preset user operation from another device (for example, a cloud server).

It may be understood that each user interface described in embodiments of this disclosure is merely an example interface, and constitutes no limitation on the solutions of this disclosure. In another embodiment, the user interface may use different interface layouts, may include more or fewer controls, and may add or reduce other function options, and provided that the user interface is based on a same idea provided in this disclosure, all fall within the protection scope of this disclosure.

It should be noted that, if no contradiction or conflict occurs, any feature or any part of any feature in any embodiment of this disclosure may be combined, and a combined technical solution also falls within the scope of embodiments of this disclosure.

In conclusion, the foregoing embodiments are merely intended for describing the technical solutions of this disclosure, but not for limiting this disclosure. Although this disclosure is described in detail with reference to the foregoing embodiments, persons of ordinary skill in the art should understand that they may still make modifications to the technical solutions described in the foregoing embodiments or make equivalent replacements to some technical features thereof, without departing from the scope of the technical solutions of embodiments of this disclosure.

What is claimed is:

1. A method implemented by an electronic device and comprising:
receiving, on a first interface of a first application that plays multimedia content, a first operation for playing first multimedia content, wherein the first interface controls playing of the multimedia content, and wherein the first operation instructs playing of the first multimedia content; and
adjusting a network for performing data communication when failing to obtain, after the first operation, a first playing start event from the first application,
wherein the first playing start event indicates that playing of the first multimedia content has started.

2. The method of claim 1, wherein the first operation matches a preset operation.

3. The method of claim 2, further comprising:
receiving a second operation on the first interface, wherein the second operation does not match the preset operation; or receiving a third operation on a second interface of the first application, wherein the second interface does not control playing of the multimedia content; and
waiting to receive a subsequent user operation.

4. The method of claim 3, further comprising:
starting playing of the first multimedia content;
pausing playing of the first multimedia content;
receiving a fourth operation on the first interface, wherein the fourth operation is for restarting playing the first multimedia content, and wherein the fourth operation matches the preset operation;
identifying that the fourth operation acts in a first area on the first interface;
adjusting the network for performing data communication when failing to obtain, within a second time period initiated by the second operation, the first playing start event from the first application; and
playing the first multimedia content when obtaining, within the second time period, the first playing start event from the first application.

5. The method of claim 1, wherein adjusting the network comprises adjusting the network from a first network to a second network, and wherein the method further comprises:
obtaining, by the first application, playing data of the first multimedia content by using the second network; and
playing the first multimedia content based on the playing data.

6. The method of claim 5, wherein after adjusting the network, the method further comprises changing a first indicator on the first interface to a second indicator on the first interface, wherein the first indicator indicates that the network for performing data communication is the first network, and wherein the second indicator indicates that the network for performing data communication is the second network.

7. The method of claim 5, wherein playing the first multimedia content comprises playing at least one of a first audio or a first video based on the playing data.

8. The method of claim 5, further comprising:
detecting a first data timeout event, wherein the first data timeout event indicates that the playing data for playing the first multimedia content in the electronic device has timed out and no playing data is currently available; and
adjusting, based on the first data timeout event, the network for performing data communication.

9. The method of claim 5, further comprising:
obtaining, after the first operation, the first playing start event from the first application;
playing the first multimedia content; and
obtaining, by the first application, from a memory or by using the network, the playing data.

10. The method of claim 1, wherein before adjusting the network, the method further comprises determining, based on activity information of the first interface, that the first interface controls playing of the multimedia content.

11. The method of claim 1, wherein before adjusting the network, the method further comprises:
obtaining a data transmission indicator after the first operation; and
detecting that the data transmission indicator indicates that network quality is poorer than a preset network quality.

12. The method of claim 11, wherein the data transmission indicator is a round-trip time (RTT).

13. The method of claim 1, further comprising:
receiving a fifth operation on a second interface of the first application, wherein the second interface controls playing of the multimedia content, and wherein the fifth operation instructs playing of second multimedia content; and
terminating one or more processes when failing to obtain, after the fifth operation, a second playing start event from the first application and when a data transmission indicator after the fifth operation indicates that a network quality is better than a preset network quality, wherein the one or more processes are not processes of the first application, and wherein the second playing start event indicates that playing of the second multimedia content has started.

14. The method of claim 1, wherein adjusting the network comprises adjusting the network when failing to obtain, within a first time period initiated by the first operation, the first playing start event.

15. An electronic device, comprising:
at least one processor;
a first application configured to:
play multimedia content; and
generate a first interface that controls playing of the multimedia content; and
a non-transitory computer-readable storage medium coupled to the at least one processor and configured to store the first application and programming instructions, wherein the programming instructions, when executed by the at least one processor, cause the electronic device to:
receive, on the first interface, a first operation and wherein the first operation instructs playing of first multimedia content; and
adjust a network for performing data communication when failing to obtain, after the first operation, a first playing start event from the first application,
wherein the first playing start event indicates that playing of the first multimedia content has started.

16. The electronic device of claim 15, wherein the first operation matches a preset operation.

17. The electronic device of claim 15, wherein the programming instructions, when executed by the at least one processor, further cause the electronic device to:
further adjust the network from a first network to a second network;
obtain by the first application, playing data of the first multimedia content by using the second network; and
play the first multimedia content based on the playing data.

18. The electronic device of claim 17, wherein after the programming instructions cause the electronic device to adjust the network, the programming instructions, when executed by the at least one processor, further cause the electronic device to change a first indicator on the first interface to a second indicator on the first interface, wherein the first indicator indicates that the network for performing data communication is the first network, and wherein the second indicator indicates that the network for performing data communication is the second network.

19. The electronic device of claim 17, wherein the programming instructions, when executed by the at least one processor, further cause the electronic device to further play the first multimedia content by playing at least one of a first audio or a first video based on the playing data.

20. The electronic device of claim 17, wherein the programming instructions, when executed by the at least one processor, further cause the electronic device to:
detect a first data timeout event, wherein the first data timeout event indicates that the playing data for playing the first multimedia content in the electronic device times out and no playing data is currently available; and
adjust, based on the first data timeout event, the network for performing data communication.
